(19) United States
(12) Patent Application Publication
(10) Pub. No.: US 2003/0175579 A1
(43) Pub. Date: Sep. 18, 2003

(54) Fuel cell electrode and fuel cell

(75) Inventors: Makoto Uchida, Osaka (JP); Eiichi Yasumoto, Soraku-gun (JP); Akihiko Yoshida, Osaka (JP); Yasushi Sugawara, Osaka (JP); Osamu Sakai, Osaka (JP); Kazuhito Hatoh, Osaka (JP); Junji Niikura, Osaka (JP); Masato Hosaka, Osaka (JP); Teruhisa Kanbara, Osaka (JP); Takeshi Yonamine, Osaka (JP); Yasuo Takebe, Uji-shi (JP); Yoshihiro Hori, Ikoma-shi (JP); Hisaaki Gyoten, Osaka (JP); Hiroki Kusakabe, Osaka (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Matsushita Electric Industrial Co., Ltd.

(21) Appl. No.: 10/367,537

(22) Filed: Feb. 14, 2003

Related U.S. Application Data
(63) Continuation of application No. PCT/JP01/06952, filed on Aug. 10, 2001.

(30) Foreign Application Priority Data
Aug. 16, 2000 (JP) JP2000-246885
Aug. 18, 2000 (JP) JP2000-248365
Sep. 13, 2000 (JP) JP2000-277776
Sep. 29, 2000 (JP) JP2000-300056

(51) Int. Cl. H01M 4/94; H01M 4/96; H01M 4/92; H01M 2/08

(52) U.S. Cl. 429/42; 429/44; 429/35

(57) ABSTRACT

To improve the performance of a catalyst layer of a fuel cell electrode, the weight ratio of a hydrogen ion conductive polymer electrolyte and electroconductive carbon particles in the catalyst layer is controlled to satisfy the formula (1): Y=a·logX−b+c, where log represents natural logarithm, X represents the specific surface area of the electroconductive carbon particles (m²/g), Y=(the weight of the hydrogen ion conductive polymer electrolyte)/(the weight of the electroconductive carbon particles), a=0.216, c=±0.300, b=0.421 at an air electrode and b=0.221 at an fuel electrode.

### CROSS-REFERENCE TO RELATED APPLICATIONS

This application is a continuation of International Patent Application No. PCT/JP01/06952, filed Aug. 10, 2001, the disclosure of which is incorporated herein by reference.

### BACKGROUND OF THE INVENTION

The present invention relates to a fuel cell electrode and a fuel cell using the electrode. More particularly, the present invention relates to a catalyst layer in an electrode which is a constituent element of a fuel cell.

Fuel cells using polymer electrolytes generate electric power and heat simultaneously by electrochemically reacting a fuel gas containing hydrogen with an oxidant gas containing oxygen, such as air or the like.

FIG. 1 is a schematic sectional view of a membrane electrode assembly (MEA), which can be used as a constituent of a polymer electrolyte-type fuel cell. As shown in FIG. 1, a catalyst layer 12 is formed on both surfaces of a polymer electrolyte membrane 11 which selectively transports a hydrogen ion. The catalyst layer 12 is formed of a mixture of a carbon powder carrying a platinum-type metal catalyst with a hydrogen ion conductive polymer electrolyte. Next, on the outside of this catalyst layer 12, a gas diffusion layer 13 having fuel gas permeability and electron conductivity is formed. As this gas diffusion layer 13, for example, water-repellent treated carbon paper is used. The catalyst layer 12 and the gas diffusion layer 13 constitute an electrode 14.

Although the catalyst layer is considered to be part of the electrode, it will be understood by those skilled in the art that, during manufacture, the material of the catalyst layer may be applied to the gas diffusion layer, to the polymer electrolyte membrane or to both, so that the electrode per se may not be completely formed until the MEA is assembled.

For prevention of leakage of a fuel gas and an oxidant gas out of a fuel cell and prevention of mutual mixing of these gases, sealing materials, such as gaskets, are placed around the electrode 14, sandwiching the polymer electrolyte membrane 11. The sealing material (not shown) is previously integrated with the electrode 14 and the polymer electrolyte membrane 11. Thus, the electrode 14 and the polymer electrolyte membrane 11 constitute MEA 15.

As the polymer electrolyte membrane 11, a perfluorocarbonsulfonic acid is generally used having a structure represented by the formula (2):

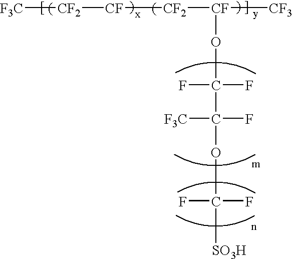

where 5≦x≦13.5, y≈1000, m=1, n=2.

FIG. 2 is a schematic sectional view of a unit cell using MEA 15 shown in FIG. 1. As shown in FIG. 2, on the outside of MEA 15, electroconductive separator plates 21 are placed for mechanically fixing the MEA in the unit cell. In parts of the separator plates 21 in contact with MEA, gas passages 22 are formed for feeding a gas to the electrode 14 and removing produced gas and excess gases. Though the gas passages 22 can also be placed as separate members on the separator plate 21, it is general practice to form grooves on the surfaces of the separator 21 to form gas passages 22.

Thus, by fixing MEA 15 by a pair of separator plates 21, a unit cell 23 is obtained. An electromotive force of about 0.8 V can be generated by feeding a fuel gas to one gas passage 22 and feeding an oxidant gas to another gas passage 22.

However, when a fuel cell is used as an electric source, voltages from several volts to several hundred volts are usually necessary. Therefore, it is actually necessary to use a number of unit cells 23 connected in series. In this case, gas passages 22 are formed on both surfaces (rear and front) of the separator plate 21, and separator plates and MEAs are successively laminated in the order:separator plate/MEA/separator plate/MEA, . . . , thus forming unit cells 23 connected in series.

For feeding a gas such as a fuel gas or an oxidant gas to the gas passage 22, it is necessary that piping for feeding a gas has a number of branches corresponding to the number of separator plates 21 to be used, and ends of the branched piping are allowed to communicate directly with the gas passages 22 of the separator plate 21. Such a jig is called a manifold, and a manifold communicating gas-feeding piping directly with a separator plate is called an outer manifold. On the other hand, manifolds including an inner manifold have a simpler structure. In the case of the inner manifold, a penetration aperture is provided in a separator plate having gas passages formed therein; the outlet and the inlet of the gas passage are connected to this aperture; and a gas is directly fed into this aperture.

Since a fuel cell generates heat in operation, it is necessary to cool the fuel cell by circulating cooling water or the like therethrough, for maintaining the fuel cell at a good temperature condition. A cooling part through which cooling water is passed is usually inserted between separator plates, at intervals of about every one to three unit cells. The cooling part may have the same structure as that of the separator plate. Actually in many cases, a passage for cooling water is provided on the rear surface of the above-mentioned separator plate (i.e., a surface not contacting a gas diffusion layer) to form a cooling part.

A plan view schematically showing the structure of the front surface (i.e., surface facing the MEA of the unit cell) of the above-mentioned separator plate 21 is shown in FIG. 3, and a plan view schematically showing the structure of the rear surface (i.e., surface facing away from the MEA) of the separator plate is shown in FIG. 4. As shown in FIG. 3, a passage for a fuel gas or an oxidant gas is formed on the surface of the separator plate 21, and as shown in FIG. 4, a passage for circulating cooling water is formed on the rear surface of the separator plate 21.

In FIG. 3, a fuel gas is charged through an aperture 31a, and discharged through an aperture 31b. On the other hand, an oxidant gas is injected through an aperture 32a, and discharged through an aperture 32b. Cooling water is injected through an aperture 33a, and cooling water is discharged through an aperture 33b. A fuel gas injected through aperture 31a is conveyed to aperture 31b through a concave part 34 constituting a gas passage, meandering on the way. A convex part 35 constitutes a gas passage together with the concave part 34. Then, the fuel gas, oxidant gas and cooling water are sealed with a sealing material 36.

The separator plate used in such a polymer electrolyte type fuel cell should have high electric conductivity and gas tightness against the fuel gas, and further, should have a high corrosion resistance, i.e., acid resistance, against an oxidation-reduction reaction between hydrogen and oxygen.

Therefore, conventional separators are produced by forming a gas passage using a cutting process on the surface of a plate made of glassy carbon, or filling a press molding die on which a gas passage has been formed with a mixture of a binder and an expanded graphite powder, performing a pressing process, and then effecting sintering by heating or the like.

Recently, there have been trials using a metal plate, such as a stainless steel plate or the like, as the material of a separator plate, instead of the carbon materials conventionally used. However, a separator plate composed of a metal plate is exposed to an oxidizing atmosphere at high temperature. Therefore, when used for a long period of time, this plate is corroded or dissolved. Additionally, there is a problem that, when a metal plate is corroded, the electric resistance at the corroded portion increases, and the output of a cell decreases.

Further, when a metal plate is dissolved, dissolved metal ions diffuse in the polymer electrolyte and are trapped at an ion exchange site in the polymer electrolyte, leading to a resulting decrease in ion conductivity of the polymer electrolyte itself. That is, the polymer electrolyte itself deteriorates. For avoiding such a deterioration, it is common to plate the surface of a metal plate with gold having a certain thickness. Further, it has also been investigated to produce a separator plate with an electroconductive resin composition obtained by mixing an epoxy resin and a metal powder.

The MEAs, separator plates and cooling parts as described above are laminated alternately to obtain a laminate composed of 10 to 200 unit cells laminated, and this laminate is sandwiched with end plates comprising a collecting plate and an insulating plate. Then, the end plates, collecting plates, insulating plates and cell laminate are fixed by fastening bolts to obtain a fuel cell stack.

FIG. 5 is a schematic perspective view of the fuel cell stack referred to here. In the fuel cell stack shown in FIG. 5, a necessary number of unit cells 41 are laminated to constitute a laminate, and the laminate is sandwiched between two end plates 42 and fastened with a plurality of fastening bolts 43. In FIG. 5 the collecting plate and the insulating plate are simply shown as an end plate. Here, on the end plate 42, an aperture 46a for charging an oxidant gas, an aperture 45a for charging a fuel gas and an aperture 44a for charging cooling water are provided. On the other hand, an aperture 46b for discharging an oxidant gas, an aperture 45b for discharging a fuel gas and an aperture 44b for discharging cooling water are also provided.

In the electrode of the polymer electrolyte fuel cell as described above, the size of the area of so-called three-phase interface, formed of fine pores serving as a feeding passages for a reaction gas, a hydrogen ion conductive polymer electrolyte, and a catalyst material which is an electron conductor, affects the discharging ability of the cell. Conventionally, for increasing the area of this three-phase interface and decreasing the amount of noble metal used as the catalyst material, trials have been conducted for mixing a hydrogen ion conductive polymer electrolyte with the catalyst material and dispersing it.

For example, Japanese Patent Publication Nos. 62-61118 and 62-61119 have suggested a method in which a mixture of a dispersion or solution of a polymer electrolyte with a catalyst material is applied on a polymer electrolyte membrane. This polymer electrolyte membrane and an electrode material are hot-pressed together and, then, the catalyst material is reduced.

Japanese Patent Publication No. 2-48632 has suggested a method in which a dispersion or solution of an ion exchange membrane resin is sprayed on a porous electrode obtained by molding, and this electrode and ion exchange membrane are hot-pressed. Further, Japanese Laid-Open Patent Publication No. 3-184266 has suggested a method in which a powder prepared by coating the surface of a polymer resin with a polymer electrolyte is mixed in an electrode, and Japanese Laid-Open Patent Publication No. 3-295172 has suggested a method in which a powder of a polymer electrolyte is mixed in an electrode.

Japanese Laid-Open Patent Publication No. 5-36418 has suggested a method in which a polymer electrolyte, a catalyst, a carbon powder and a fluorocarbon resin are mixed, and the obtained mixture is molded in the form of membrane to obtain an electrode.

U.S. Pat. No. 5,211,984 has suggested a method in which a polymer electrolyte, a catalyst and a carbon powder are dispersed in the form of ink into a solvent of glycerin or tetrabutylammonium salt to prepare a dispersion. A membrane made of the obtained dispersion is molded on a polytetrafluoroethylene (PTFE) film, and the obtained membrane is then transferred onto the surface of a solid polymer electrolyte membrane. Further reported are a method in which an exchange group of a solid polymer electrolyte membrane is substituted by Na type, the above-mentioned dispersion in the form of an ink is applied on the surface of the membrane and heated to dry at a temperature of 125° C. or higher, and the above-mentioned exchange group is substituted again by H type, and other methods.

### BRIEF SUMMARY OF THE INVENTION

The present invention relates to an electrode for a fuel cell, particularly a polymer electrolyte fuel cell, and a fuel cell comprising a hydrogen ion conductive polymer electrolyte membrane, a pair of electrodes disposed so as to sandwich the hydrogen ion conductive polymer electrolyte membrane, and a pair of separator plates having gas passages feeding a fuel gas to and discharging a fuel gas from one of the electrodes and gas passages feeding an oxidant gas to and discharging an oxidant gas from another electrode, wherein:

the electrode comprises a gas diffusion layer and a catalyst layer in contact with the hydrogen ion conductive polymer electrolyte membrane;

the catalyst layer comprises a hydrogen ion conductive polymer electrolyte and electroconductive carbon particles carrying catalyst particles; and

the hydrogen ion conductive polymer electrolyte and the electroconductive carbon particles in the catalyst layer satisfy the formula (1):

Y=a logX−b+c

where log represents natural logarithm, X represents the specific surface area of the electroconductive carbon particles (m²/g), Y=(the weight of the hydrogen ion conductive polymer electrolyte)/(the weight of the electroconductive carbon particles), a=0.216, c=+0.300, b=0.421 at an air electrode and b=0.221 at an fuel electrode.

Particularly effective results have been achieved using additional features of the present invention. Accordingly, the following features of the invention are preferred and may be used in electrodes and fuel cells of the invention either individually or with two or more features in combination.

The catalyst layer should contain electroconductive carbon particles having a primary particle size in a range of about 10 nm to about 150 nm, a hydrogen ion conductive polymer electrolyte and platinum, and have a layer thickness in a range of about 3 μm to about 10 μm. As used herein, “primary particle size” refers to average particle diameter of primary particles, i.e., individual particles which have not been agglomerated or otherwise combined in forming the layer. Particle sizes referred to herein were determined by visual inspection of the particle layer by transmission electron microscope (TEM).

The electrode should have a water-repellent layer between the catalyst layer and the gas diffusion layer. The water-repellent layer should contain electroconductive carbon particles having a primary particle size in a range of about 10 nm to about 150 nm and a water-repellent agent. Portions of the water-repellent layer not intruding into the gas diffusion layer should have an average thickness in a range of about 5 μm to about 50 μm.

The average thickness of the gas diffusion layer should be in a range of about 250 μm to about 400 μm.

The catalyst layer should have a porosity in a range of about 30% to about 70%, and the water-repellent layer should have a porosity in a range of about 30% to about 60%.

The fuel cell should have a sealing material around the peripheral parts of the electrode, and the spacing between the electrode and the above-mentioned sealing material should be in a range of about 10 μm to about 1 mm.

The polymer of the hydrogen ion conductive polymer electrolyte should have a main chain skeleton comprised of fluorocarbon and a side chain having an end group comprised of sulfonic acid or alkylsulfonic acid. The electrolyte should have an equivalent (Eq) weight in a range of about 80 g/Eq to about 1100 g/Eq. The “equivalent weight” means the weight of the whole electrolyte giving 1 mol of sulfone group.

The electroconductive carbon particles should have a specific surface area in a range of about 50 m²/g to about 1500 m²/g.

The electroconductive carbon particles should contain a graphitized carbon powder in an amount of at least about 33% by weight. The lattice plane spacing d₀₀₂ of the (002) plane in the crystal structure of the above-mentioned graphitized carbon powder should be in a range of about 3.35 Å to about 3.44 Å. The graphitized carbon powder should be one obtained by thermally treating a carbon powder at at least about 2000° C.

The electroconductive carbon particles should have a specific surface area in a range of about 58 m²/g to about 1500 m²/g, and the catalyst particles should be carried only on the outside of the electroconductive carbon particles.

An end cation part composed of a polar functional group present on the outer surface of the electroconductive carbon particle should be substituted by a catalyst cation.

The catalyst particles should have a specific surface area in a range of about 50 m²/g to about 250 m²/g.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic sectional view of a conventional membrane electrode assembly (MEA) constituting a polymer electrolyte fuel cell.

FIG. 2 is a schematic sectional view of a conventional unit cell using the MEA shown in FIG. 1.

FIG. 3 is a plan view schematically showing the structure of the front surface of a conventional separator plate.

FIG. 4 is a plan view schematically showing the structure of the rear surface of a conventional separator plate.

FIG. 5 is a schematic sectional view of a conventional fuel cell stack.

FIG. 6 is a graph showing the relation between the weight ratio of polymer electrolyte/electroconductive carbon particles and the output voltage per unit cell in Example 1.

FIG. 7 is a graph showing the relation between the weight ratio of polymer electrolyte/electroconductive carbon particles and the output voltage per unit cell in Example 2.

FIG. 8 is a graph showing the relation between the weight ratio of polymer electrolyte/electroconductive carbon particles and the output voltage per unit cell in Example 3.

FIG. 9 is a graph showing the relation between the weight ratio of polymer electrolyte/electroconductive carbon particles and the output voltage per unit cell in Example 4.

FIG. 10 is a graph showing the relation between the weight ratio of polymer electrolyte/electroconductive carbon particles and the output voltage per unit cell in Example 5.

FIG. 11 is a graph showing the relation between the weight ratio of polymer electrolyte/electroconductive carbon particles and the output voltage per unit cell in Example 6.

FIG. 12 is a graph showing the relation between the weight ratio of polymer electrolyte/electroconductive carbon particles and the output voltage per unit cell in Example 7.

FIG. 13 is a graph showing the relation between the weight ratio of polymer electrolyte/electroconductive carbon particles and the specific surface area of the electroconductive carbon particles, when the output voltage is highest in FIGS. 6 to 12.

FIGS. 14(a) and 14(b) are schematic sectional views conceptually showing the structure of the primary particles of a graphitized carbon powder (a) and a usual carbon powder (b).

FIG. 15 is a schematic perspective view showing the fine crystal structure of carbon black, which is a conventionally used carbon powder.

FIG. 16 is a graph showing the relation between the operation time (in hours) of four hydrogen-air type cells and the voltage per one cell (unit cell) in Examples 42-45.

FIG. 17 is a graph showing the relation between the operation time (in hours) of four liquid fuel cells and the voltage per one cell (unit cell) in Examples 42-45.

FIG. 18 is a schematic sectional view showing catalyst-carrying particles, which carry catalyst particles only on the outer surface of the electroconductive carbon particles.

FIG. 19 is graph showing current-voltage (I-V) curves of three unit cells in Examples 46-48.

FIG. 20 is a schematic sectional view showing catalyst-carrying particles, which carry catalyst particles on the outer surface and the inner surface of the electroconductive carbon particles.

### DETAILED DESCRIPTION OF THE INVENTION

As described above, the present invention is characterized in that, in an electrode having a gas diffusion layer and a catalyst layer in a fuel cell, the catalyst layer is formed of a hydrogen ion conductive polymer electrolyte and electroconductive carbon particles carrying catalyst particles, and the weight of the hydrogen ion conductive polymer electrolyte and the weight of the electroconductive carbon particles in the catalyst layer are controlled to satisfy the formula (1):

Y=a·logX−b+c

where log represents natural logarithm, X represents the specific surface area of the electroconductive carbon particles (m²/g), Y=(the weight of the hydrogen ion conductive polymer electrolyte)/(the weight of the electroconductive carbon particles), a=0.216, c=+0.300, b=0.421 at an air electrode and b=0.221 at a fuel electrode.

It has been noticed that if an excessive amount of a hydrogen ion conductive polymer electrolyte is present in a catalyst layer, electron conductivity in the electrode is remarkably decreased, and at the same time, fine pores serving as feeding passages for the reaction gas are clogged, thereby decreasing power generation properties. On the other hand, when the amount of hydrogen ion conductive polymer electrolyte is deficient, hydrogen ion conductivity decreases, and power generation properties decrease problematically. However, in a catalyst layer composed of a hydrogen ion conductive polymer electrolyte and a carbon powder carrying a noble metal catalyst, an influence exerted on power generation properties by the mixing ratio of a catalyst material and a polymer electrolyte has not been apparent up till now.

According to the present invention, a relationship has been devised among the hydrogen ion conductive polymer electrolyte, the catalyst particles and the carbon powder in a catalyst layer of an electrode of a fuel cell, in order to provide a fuel cell having excellent power generation properties.

On the other hand, the electrode reaction of a fuel cell is controlled by diffusion in a region of relatively higher current density of 0.1 A/cm² or more. That is, gas diffusion rate controls the rate of the electrode reaction. Therefore, for improving the performance of a cell, it is necessary to improve gas diffusion efficiency.

For improvement of the gas diffusion efficiency in the reaction at the air electrode side, oxygen, which is the active substance in air, cannot be efficiently fed to the electrode unless product water is removed efficiently from the vicinity of the surface of the air electrode. Therefore, particularly at the air electrode side, an improved electrode structure for enhancing diffusion efficiency was necessary. Usually, therefore, the catalyst layer is made porous as much as possible by mixing a pore-forming agent during production of the catalyst layer by molding, and removing the pore-forming agent after the molding. Specifically, a porosity of 70% or more is usually achieved.

However, when increasing the porosity of the catalyst layer and securing a constant catalyst amount per unit electrode area are intended, the following problem occurs. For example, for securing a catalyst amount of about 0.5 mg/cm², the thickness of the catalyst layer should be relatively increased. Here, when the thickness of the catalyst layer is increased, the utilization efficiency of the catalyst decreases in portions of the catalyst layer remote from the polymer electrolyte membrane, as compared with portions adjacent to the polymer electrolyte membrane. Further, when the thickness of the catalyst layer becomes larger, the cell performance is improved further, but improvement in the cell performance is gradually saturated. However, sufficient cell performance is not obtained unless the thickness of a catalyst layer is so increased.

When the MEA for conventional polymer electrolyte fuel cells is produced, an electrode or gas diffusion layer and a polymer electrolyte membrane with catalyst layer therebetween are joined by hot pressing. Further, for fastening a stack formed by laminating unit cells, it is usual to fix the laminated stack with a fastening pressure of about 10 to 20 kgf/cm². Anyway, application of high pressure to the MEA by hot pressing and fastening pressure cannot be avoided. Therefore, particularly when a gas diffusion layer comprises a hard carbon non-woven fabric, the polymer electrolyte membrane is injured or deformed by the gas diffusion layer. Further, there is a risk of formation of cracks, pinholes and the like on the polymer electrolyte membrane. When pinholes occur on a polymer electrolyte membrane, hydrogen as a fuel and air as an oxidant are cross-leaked and burnt, leading not only to decreases in the performance of the fuel cell, but also to increases in the size of pinholes produced on the polymer electrolyte membrane by burning heat and, in some cases, even to adverse influences exerted on the separator plates.

Further, electrical conductivity across the surface area of the whole electrode is insufficient with the electrical conductivity of the catalyst layer and the water-repellent layer alone; therefore, an electroconductive material is generally used for a gas diffusion layer itself. The gas diffusion layer compensates insufficient electric collection of the catalyst layer, diffuses a gas, and additionally facilitates discharge of excess water generated in the catalyst layer by the cell reaction. Therefore, from the standpoint of gas diffusion efficiency, a thinner gas diffusion layer is believed to be more effective. However, from the standpoint of efficiency in discharging excess water, a larger volume of parts of the gas diffusion layer for holding water is more effective. Therefore, when the thickness of the gas diffusion layer is larger, evaporation of water can be effectively facilitated. Further, when the thickness of the gas diffusion layer is decreased, pressure loss of the feeding gas increases, and when the efficiency of the whole fuel cell power generation system is taken into consideration, auxiliary mobility increases and the system efficiency decreases problematically.

According to the present invention, there are provided an optimum MEA capable of producing a fuel cell having an excellent power generation performance and a fuel cell power generation system having an excellent system efficiency. In this regard, the present invention relates to a catalyst layer and a gas diffusion layer particularly constituting the MEA, and a water-repellent layer which can be formed between them.

Next, the gas diffusion layer and catalyst layer constituting the electrode of the fuel cell, as described above, will be explained particularly in detail below. The gas diffusion layer has mainly the following three functions. The first function is to diffuse a reaction gas, such as a fuel gas or oxidant gas, so as to uniformly feed the reaction gas from a gas passage formed on an outer surface of the gas diffusion layer to the catalyst in the catalyst layer. The second function is to quickly discharge into a gas passage water produced by the reaction in the catalyst layer. The third function is to conduct electrons necessary for the reaction or generated electrons. That is, the gas diffusion layer is required to have high reaction gas permeability, water vapor permeability and electron conductivity.

As a conventional general technology, a gas diffusion layer having a porous structure is obtained by using a fine carbon powder having a developed structure, a pore-forming agent, and an electroconductive porous substrate, such as carbon paper or carbon cloth, for imparting gas permeability to the gas diffusion layer. For imparting water vapor permeability to the gas diffusion layer, water-repellent polymers, typified by fluorocarbon resins and the like, are dispersed in the gas diffusion layer. Finally, for imparting electron conductivity, the gas diffusion layer is constituted of an electron conductive material, such as carbon fiber, metal fiber or fine carbon powder.

The catalyst layer has mainly the following four functions. The first function is to feed a reaction gas, such as a fuel gas or oxidant gas, fed from the gas diffusion layer to a reaction site of the catalyst layer. The second function is to quickly transfer to the electrolyte membrane hydrogen ions necessary for the reaction on the catalyst or produced hydrogen ions. The third function is to transfer electrons necessary for the reaction or generated electrons. The fourth function is high catalytic ability for quick reaction and a wide reaction area thereof. That is, the catalyst layer is required to have high reaction gas permeability, hydrogen ion permeability, electron conductivity, and catalytic ability.

As a conventional general technology, the catalyst layer having a porous structure is obtained by using a fine carbon powder having a developed structure and a pore-forming agent, for imparting gas permeability to the catalyst layer. Further, for imparting hydrogen ion permeability to the catalyst layer, a polymer electrolyte is dispersed in portions around the catalyst in the catalyst layer, and a hydrogen ion network is formed. For imparting electron conductivity to the catalyst layer, an electron conductive material, such as a fine carbon powder or a carbon fiber, is used as a catalyst carrier. Finally, for improving catalytic ability, a metal catalyst having high reaction activity, typified by platinum, is prepared to have a particle size of several nm. This very fine particle is carried on a fine carbon powder, and the thus-obtained catalyst-carrying particles are dispersed in the catalyst layer.

Here, the electroconductive carbon particle (fine carbon particle) used in the gas diffusion layer and the catalyst layer of the above-mentioned MEA is explained. The fine carbon powder is a black powder of amorphous carbon having a diameter of about 3 to 500 nm, not easily wetted with water, and has a specific gravity of about 1.8 to 1.9 and an apparent specific gravity of about 0.35 to 0.4 in terms of particle and about 0.04 to 0.08 in terms of powder. Though the fine carbon powder can be produced by thermally decomposing hydrocarbons, considerably varying products are obtained depending on differences in production methods, production conditions and the like. In any method, a raw material hydrocarbon is carbonized at a high temperature of at least about 800° C. for a short period of time such as several milli-seconds.

In a crystal structure as a base of the fine carbon powder, crystallites having a disorderly layered structure, which comprises a several layers of aromatic plane molecules having an average size of about 10 to 30, aggregate complicatedly to constitute spherical particles. These spherical particles further bond to constitute an aggregate (structure) in the form of chain. The microscopic condition of the surface of this fine carbon powder differs from the condition of a simple fine particle of carbon, and an acidic functional group and other functional groups are present on the surface of the particle. Therefore, it has special industrial applications such as a rubber-reinforcing agent.

The hydrocarbons used for a raw material include natural gas, coal gas, acetylene gas, petroleum-based heavy oil, petroleum, creosote oil, naphthalene, anthracene and the like. The carbonized hydrocarbons are classified into gas black, oil black, acetylene black, and the like, depending on the raw material.

90% or more of the fine carbon powders are used as various rubber-reinforcing agents (about 80% of them are for tires), and are widely used for plastic reinforcing fillers, printing inks, paints, electric wires, electric columns, and dry batteries, as well as for carbon paper, Japanese ink, pigments, pencils, crayons, catalyst carriers, fireworks, thawing agents, and the like.

The main method of producing the fine carbon powder is as described below. The currently dominant furnace method was developed in the U.S. during World War II. At first, gases were used as a raw material, but recently oils are used, and those of high quality are obtained at high yield. The raw material and air are blown into a furnace (burning furnace); the raw material is incompletely burnt continuously under turbulent diffusion; the burnt gas is passed through a cooler and is collected in a bag filter and then granulated. For example, the furnace temperature is about 1600° C., and the burnt products are hydrogen, carbon monoxide, carbon dioxide, water vapor, and carbon black (furnace black). Cooling is conducted by spraying water, where first, the primary cooling temperature is controlled at about 900° C. and the second cooling temperature is controlled at about 400° C.

In the thermal method, natural gas as a raw material is fed to a sufficiently heated checker structure (obtained by combining fireproof red bricks with clearance) to cause thermal decomposition, and a cycle mode operation is conducted without using oxygen.

However, since the wetting property of the fine carbon powder used in such a catalyst layer and gas diffusion layer increases with the lapse of time, it is a problem if fine pores serving as a reaction gas feeding passages are clogged in the catalyst layer and the gas diffusion layer by the produced water and water contained in a reaction gas for moistening. Consequently, a reaction gas is not fed sufficiently, causing a decrease in the cell performance.

A reason for possible increase in wetting property of such a fine carbon powder is believed to be that, since a conventionally used fine carbon powder is insufficiently graphitized, various functional groups are present on the surface, surface energy for water is high, and contact angle is small, so that consequently, moisture absorption proceeds gradually.

According to the present invention, the above-mentioned conventional problems are solved, and an electrode for a fuel cell is provided exhibiting higher performance by optimizing the water repellency of fine carbon particles in the catalyst layer and the gas diffusion layer. A polymer electrolyte type fuel cell and a liquid fuel cell using this electrode are also provided.

The invention will now be further explained and illustrated with reference to the following specific, non-limiting examples, together with the accompanying drawings.

### EXAMPLES 1 TO 7

First, an MEA was produced according to the following method. A dispersion of polytetrafluoroethylene (Lubron™ LDW-40 manufactured by Daikin Industries, Ltd.) was mixed in an amount of 30% by weight by dry weight with an electroconductive carbon particle powder (Denka Black™ manufactured by Denki Kagaku Kogyo K. K.) to produce a water-repellent layer ink. Next, the water-repellent layer ink was coated on the surface of carbon paper (TGPH060H manufactured by Toray Industries, Inc.), and the coated paper was heated at 350° C. by a hot air dryer to form a gas diffusion layer.

Then, platinum particles having an average particle size of about 30 Å were carried on electroconductive carbon particles having a specific surface area of 70 m²/g (Denka Black™ manufactured by Denki Kagaku Kogyo K. K.) to obtain catalyst-carrying particles. 25% by weight of the catalyst-carrying particles were platinum particles. The catalyst-carrying particles and a dispersion or solution of a hydrogen ion conductive polymer electrolyte were mixed to obtain a catalyst paste. In this procedure, the catalyst-carrying particles and the hydrogen ion conductive polymer electrolyte were mixed so that the weight ratio of polymer electrolyte/electroconductive carbon particles was about 0.2 to 2.0. As the hydrogen ion conductive polymer electrolyte, a perfluorocarbonsulfonic acid having an equivalent weight of 1000 to 1100 g/Eq was used.

Next, the catalyst paste was printed on one surface of each gas diffusion layer and on both surfaces of a hydrogen ion conductive polymer electrolyte membrane (Nafion™ 112 manufactured by E. I. Du Pont de Nemours and Company, U.S.). The gas diffusion layers were then laminated on the fuel electrode side and on the air electrode side respectively of the membrane, so that the catalyst paste surfaces faced each other while mutually sandwiching the hydrogen ion conductive polymer electrolyte membrane at the center, and these were fixed together by a hot press method. By this method, a membrane electrode assembly (MEA) was obtained. A gasket plate made of butyl rubber was connected to the outer peripheral parts of the polymer electrolyte membrane of the MEA, and manifold apertures for passing cooling water, fuel gas and oxidant gas were formed in the gasket plate.

Next, separator plates constituted of resin impregnated graphite plates with a dimension of 20 cm×32 cm×1.3 mm and having gas passages and cooling water passages of a depth of 0.5 mm were prepared. On one surface of the MEA a separator plate having oxidant gas passages formed therein was laminated, and on another surface of the MEA a separator plate containing fuel gas passages formed therein was laminated, to obtain a unit cell. Two of these unit cells were laminated together, and this two unit cell-laminate was then sandwiched by separator plates having cooling passages formed therein. A plurality of these two unit cell laminates were laminated together to produce a cell stack containing 100 unit cells. Then, at both ends of the cell stack a collecting plate made of stainless steel, an insulating plate made of an electrically insulating material and an end plate were fixed by fastening rods. The fastening pressure under this condition was 10 kgf/cm² per area of the separator plate.

A pure hydrogen gas was fed to the fuel electrode and air was fed to the air electrode of the thus-produced polymer electrolyte fuel cell in this example. Under conditions of a cell temperature of 75° C., a fuel gas utilization (Uf) of 70% and an air utilization (Uo) of 40%, the cell properties of the above-mentioned cell stack were evaluated. The fuel gas was passed through hot water of 75° C. for humidification, and air was passed through hot water of 50° C. for humidification.

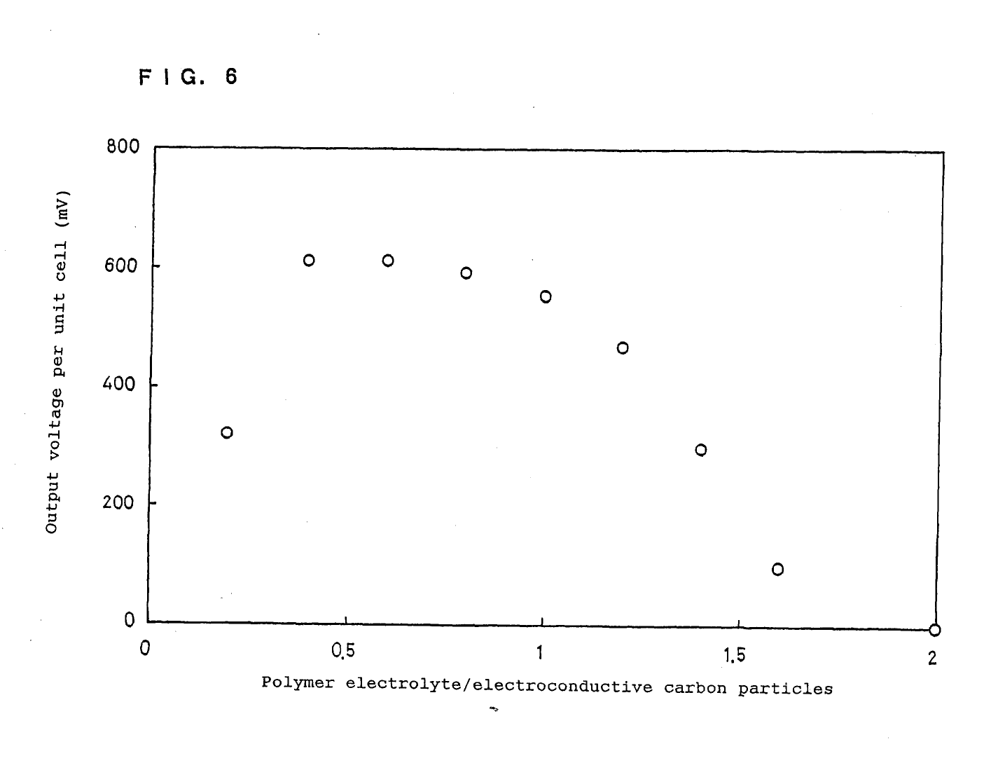

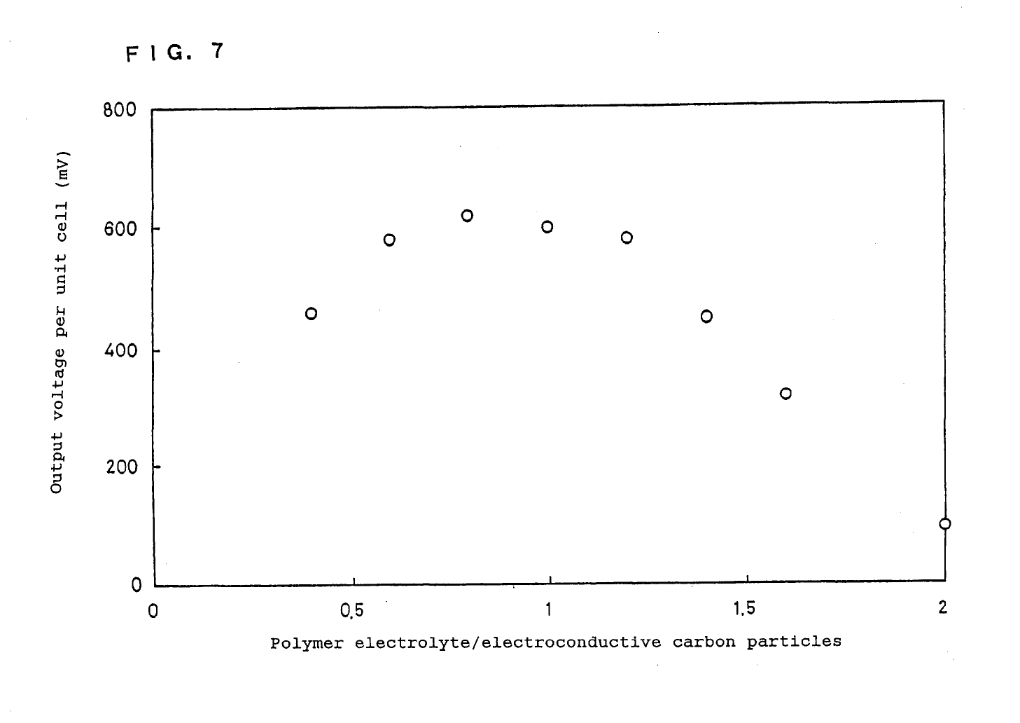

FIGS. 6 to 12 show the output voltage of the cells when the current density was 700 mA/cm². FIGS. 6 to 12 are graphs showing the relation between the weight ratio of polymer electrolyte/electroconductive carbon particles and the output voltage per unit cell for the experimental cells of Examples 1-7, respectively, as prepared and tested according to the above-described procedures, which were the same in each example, except as differentiated below.

From FIG. 6, it was found that when the specific surface area of electroconductive carbon particles is 70 m²/g and the catalyst-carrying particles carry 25 wt % of platinum particles, the weight ratio of polymer electrolyte/electroconductive carbon particles at which the output voltage is most excellent is 0.5 (Example 1).

In contrast to Example 1, platinum was carried on electroconductive carbon particles having a specific surface area of 250 m²/g (Vulcan XC manufactured by Cabot). The results are shown in FIG. 7, where it was found that when the specific surface area of the electroconductive carbon particles is 250 m²/g and catalyst-carrying particles carry 25 wt % of platinum particles, the weight ratio of polymer electrolyte/electroconductive carbon particles at which the output voltage is most excellent is 0.8 (Example 2).

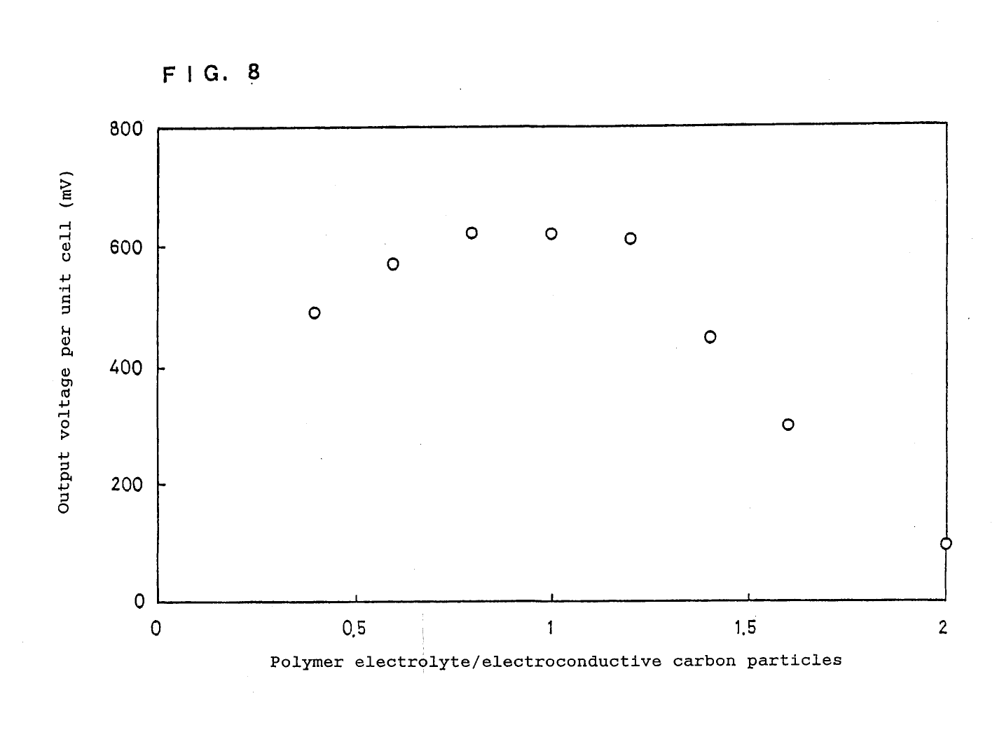

Next, platinum was carried on electroconductive carbon particle having a specific surface area of 800 m²/g (Ketjen Black™ EC manufactured by Lion Corp.). The results are shown in FIG. 8, from which it was found that when the specific surface of electroconductive carbon particles is 800 m²/g and catalyst-carrying particles carry 25 wt % of platinum particles, the weight ratio of polymer electrolyte/the electroconductive carbon particles at which the output voltage is most excellent is 0.9 (Example 3).

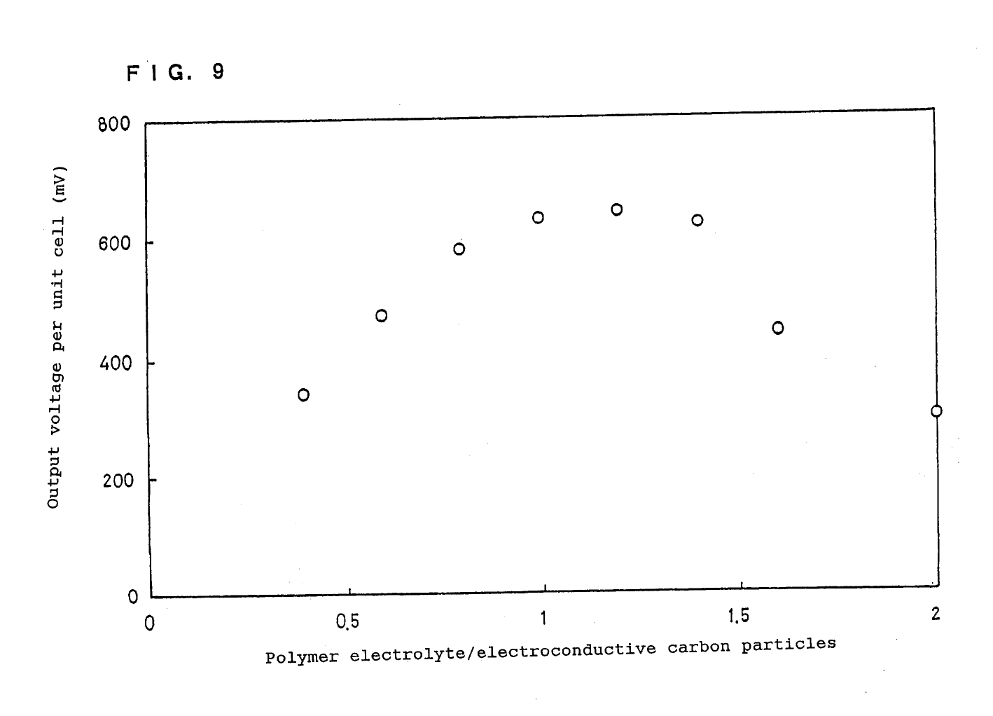

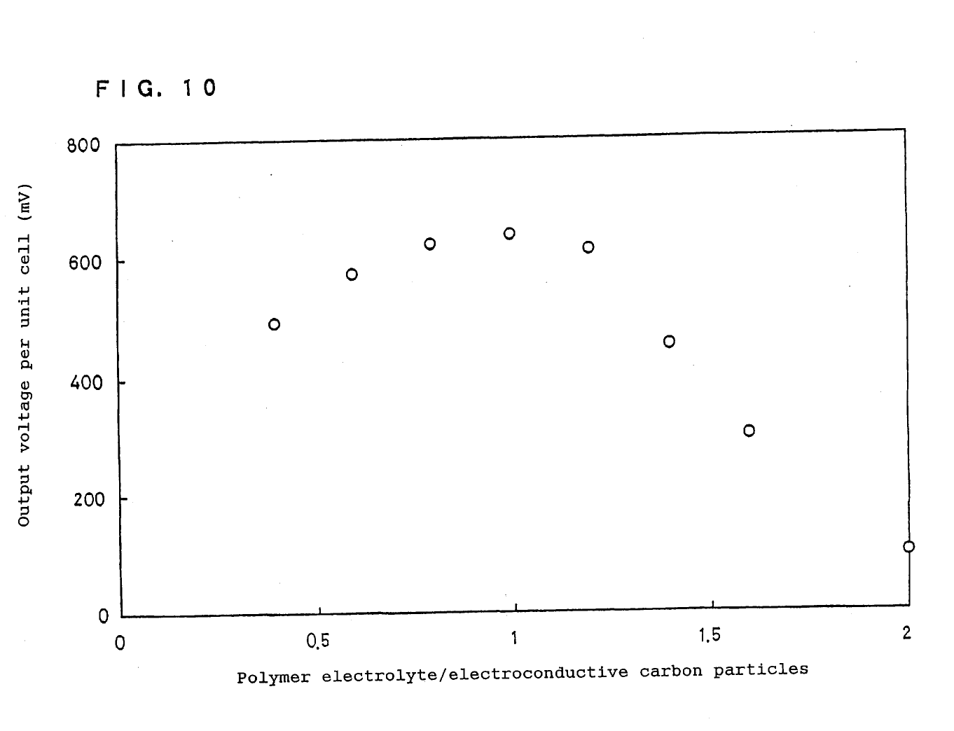

Next, the above-mentioned platinum particles were carried on electroconductive carbon particles having a specific surface area of 1270 m²/g (Ketjen Black™ 600 JD manufactured by Lion Corp.). The results are shown in FIG. 9, from which it was found that when the specific surface area of the electroconductive carbon particles is 1270 m²/g and catalyst-carrying particles carry 25 wt % of platinum particles, the weight ratio of polymer electrolyte/electroconductive carbon particles at which the output voltage is most excellent is 1.2 (Example 4).

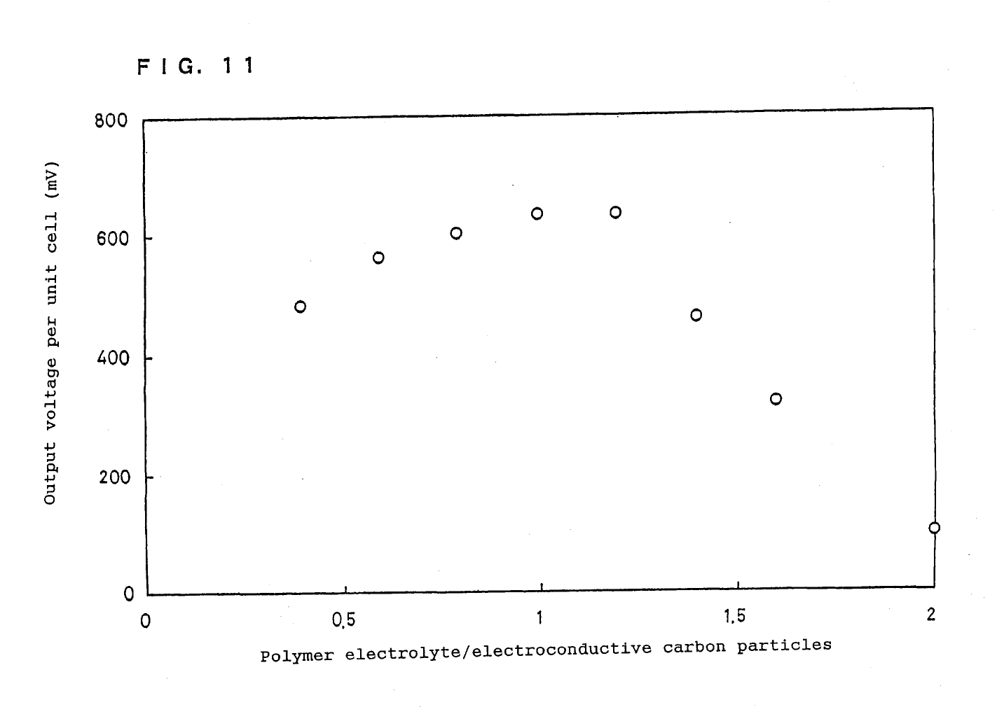

Though 25 wt % of platinum was carried on electroconductive carbon particles having a specific surface area of 800 m²/g in Example 3, 50 wt % of platinum was carried in this example. That is, 50 wt % of the catalyst-carrying particles were platinum particles. The results are shown in FIG. 10, from which it was found that when the specific surface area of the electroconductive carbon particles is 800 m²/g and catalyst-carrying particles carry 25 wt % of platinum particles, the weight ratio of polymer electrolyte/electroconductive carbon particles at which the output voltage is most excellent is 1.0 (Example 5).

Though a perfluorocarbonsulfonic acid having an equivalent weight of 1000 to 1100 g/Eq was used in preparing the catalyst paste in Example 1, a perfluorocarbonsulfonic acid having an equivalent weight of 900 g/Eq was used in this example. A catalyst past was prepared with this perfluorocarbonsulfonic acid and catalyst-carrying particles (containing 50 wt % of platinum particles) obtained by carrying platinum particles on electroconductive carbon particles having a specific surface area of 800 m²/g (Ketjen Black™ EC manufactured by Lion Corp.). The results are shown in FIG. 11, from which it was found that when the specific surface area of the electroconductive carbon particles is 800 m²/g and a hydrogen ion conductive polymer has an equivalent weight of 900 g/Eq, the weight ratio of polymer electrolyte/electroconductive carbon particles at which the output voltage is most excellent is 1.1 (Example 6).

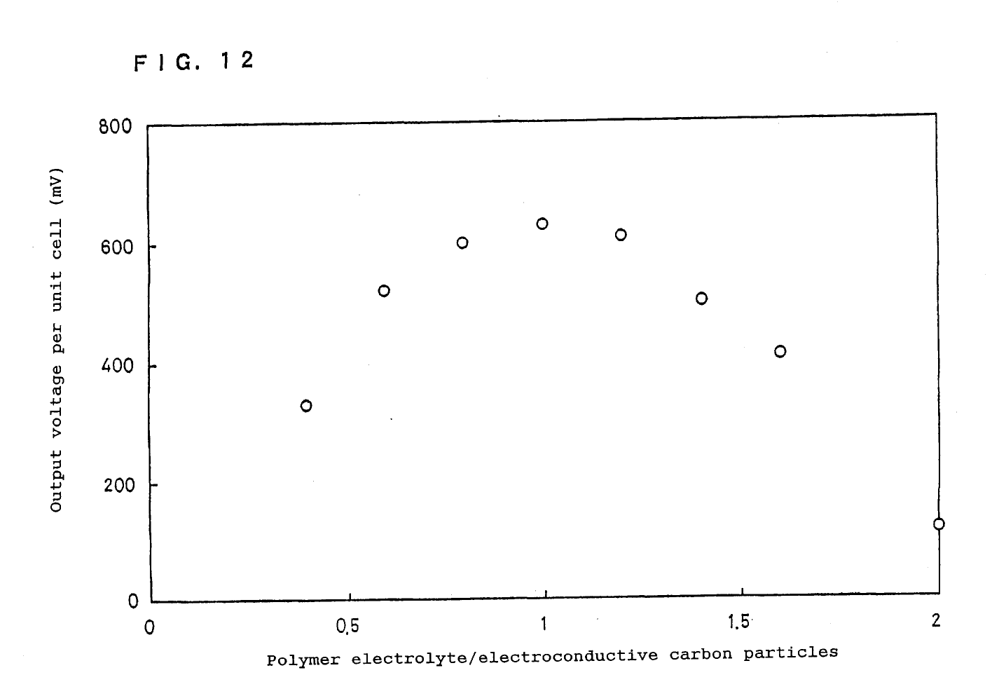

Next, a catalyst paste was prepared using a perfluorocarbonsulfonic acid having an equivalent weight of 800 to 850 g/Eq. The results are shown in FIG. 12, from which it was found that when the specific surface area of the electroconductive carbon particles is 800 m²/g and a polymer has an equivalent weight of 800 to 850 g/Eq, the weight ratio of polymer electrolyte/electroconductive carbon particles at which the output voltage is most excellent is 1.0 (Example 7).

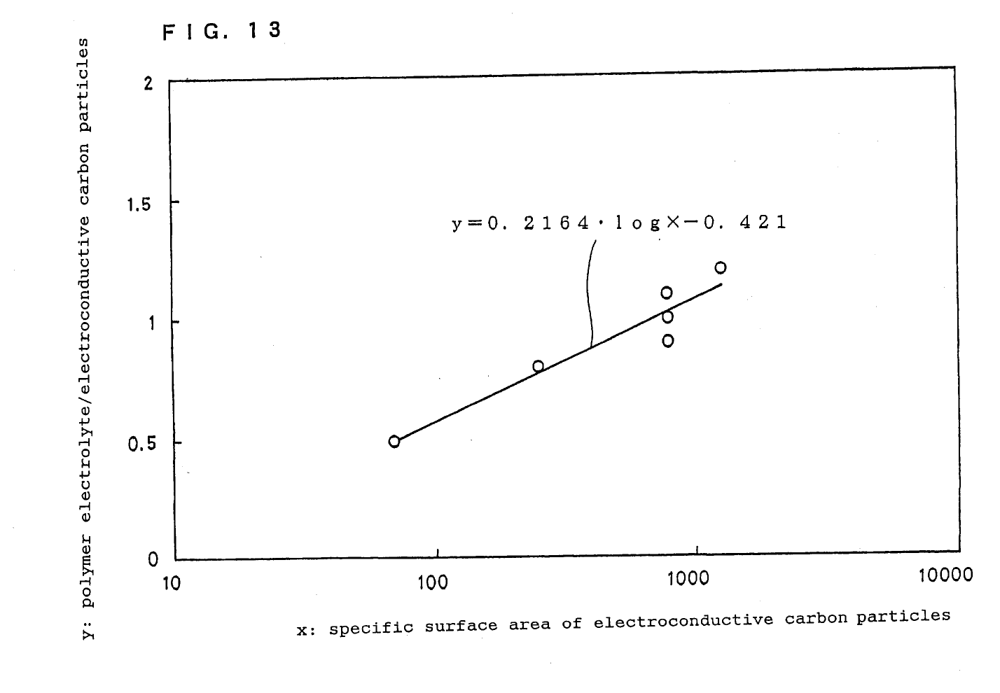

Based on the above-mentioned results, FIG. 13 shows the relation between the weight ratio of polymer electrolyte/electroconductive carbon particles and the specific surface area of the electroconductive carbon particles, at which the output voltage is most excellent, from FIGS. 6 to 12. A straight line was drawn in FIG. 13, and this line was analyzed to obtain a formula: y=0.2164 logX−0.421. When the inclination of the above-mentioned straight line was changed in the permissible range in FIG. 8, the formula (1): Y=a*logX−b+c was obtained, where log represents natural logarithm, X represents the specific surface area of the electroconductive carbon particles, Y=(the weight of the hydrogen ion conductive polymer electrolyte)/(the weight of the electroconductive carbon particles), a=0.216, c=+0.300, b=0.421 at an air electrode and b=0.221 at a fuel electrode. That is, it was found preferable that the hydrogen ion conductive polymer electrolyte, catalyst particles and electroconductive carbon particles in the above-mentioned catalyst layer satisfy the formula (1). Particularly, it was found preferable that b=0.421 at an air electrode and b=0.221 at a fuel electrode.

From FIG. 13 it was found that polymer electrolyte/electroconductive carbon particles at which the output voltage is most excellent is hardly dependent on the Pt carrying ratio and the equivalent weight of a hydrogen ion conductive polymer electrolyte dispersed in the catalyst. That is, it was found that the output voltage of a fuel cell can be enhanced by controlling the amount of a hydrogen ion conductive polymer electrolyte introduced in the catalyst layer according to the formula (1) from the specific surface area of electroconductive carbon particles used as a catalyst material. As described above, the output performance of a fuel cell can be enhanced according to the present invention.

### EXAMPLES 8 TO 41

The following examples were conducted to determine suitable constitutions of the catalyst layer, water-repellent layer, gas diffusion layer, and the like.

Electroconductive carbon particles having a primary particle size in a range of about 10 nm to about 150 nm (Vulcan™ XC manufactured by Cabot) were allowed to carry platinum particles having an average particle size of about 30 Å to obtain catalyst-carrying particles for an air electrode (containing 50 wt % of platinum particles). Further, the carbon black was allowed to carry platinum-ruthenium alloy particles having an average particle size of about 30 Å to obtain catalyst-carrying particles for a fuel electrode (containing 50 wt % of platinum-ruthenium alloy particles). As the hydrogen ion conductive polymer electrolyte, a perfluorocarbonsulfonic acid of a chemical formula shown in the formula (2) was used.

20 parts by weight of the catalyst-carrying particles and 80 parts by weight of an ethanol dispersion or solution containing 9 wt % of hydrogen ion conductive polymer electrolyte were mixed by ball mill to prepare an electrode ink. In this case, for producing a catalyst layer having a thickness of over 10 μm and having a large porosity for comparison, 20 wt % of a pore-forming agents were added to the electrode ink to prepare an electrode ink. After production of a catalyst layer containing the pore-forming agent, the pore-forming agent was removed by thermal treatment.

Then, an ethanol dispersion or solution containing 9 wt % of a hydrogen ion conductive polymer electrolyte was cast on a smooth glass substrate, and dried to obtain a hydrogen ion conductive polymer electrolyte membrane having an average membrane thickness of 30 μm. Then, on both surfaces of this hydrogen ion conductive polymer electrolyte membrane, the electrode ink and the pore-forming agent-containing electrode ink were printed by a screen printing method, to obtain a polymer electrolyte membrane with catalyst layers.

Carbon paper was used as the gas diffusion layers, and water-repellent treatment was performed on these. Carbon non-woven fabric (TGP-H-120 manufactured by Toray Industries, Inc.) of 16 cm×20 cm×360 μm was immersed in an aqueous dispersion containing a fluorocarbon resin (Neofron™ ND1 manufactured by Daikin Industries, Ltd.). The impregnated paper was dried and heated at 400° C. for 30 minutes to give water repellency.

Next, electroconductive carbon particles (carbon black) having a primary particle size in a range of about 10 nm to about 150 nm and an aqueous dispersion of a PTFE powder were mixed to prepare a water-repellent layer ink.

Further, the water-repellent layer ink was applied by a screen printing method to form a water-repellent layer on one surface of the carbon non-woven fabric to be used as the gas diffusion layers. In this condition, a part of the water-repellent layer was intruded into, that is, impregnated into the carbon non-woven fabric. By controlling the viscosity of the water-repellent layer ink, the thickness of parts of the water-repellent layer not impregnated into the diffusion layer was controlled.

Then, on both surfaces of the polymer electrolyte membrane with catalyst layer, a pair of diffusion layers with water-repellent layer were bonded by a hot press, so that the water-repellent layer was in contact with the catalyst layer on the polymer electrolyte membrane, thus obtaining a membrane/electrode assembly (MEA).

This MEA was thermally treated for 1 hour in a saturated water vapor atmosphere at 120° C. to allow conducting passages to develop sufficiently. Here, it was found that when a hydrogen ion conductive polymer electrolyte of the formula (2) is thermally treated under a wet atmosphere at a relatively high temperature of at least about 100° C., a hydrophilic channel as a hydrogen ion conductive passage is developed to form a reverse micelle structure.

Thus, an electrode of 16 cm×20 cm was laminated on both surfaces of a hydrogen ion conductive polymer electrolyte membrane of 20 cm×32 cm to obtain an MEA containing electroconductive carbon particles carrying a catalyst for electrode reaction.

Next, a gasket plate made of rubber was connected to the outer peripheral parts of the polymer electrolyte membrane of the MEA, and manifold apertures for passing cooling water, fuel gas and oxidant gas were formed in the gasket.

Then, separator plates constituted of resin-impregnated graphite plates with a dimension of 20 cm×32 cm×1.3 mm and having gas passages and cooling water passages of a depth of 0.5 mm were prepared. On one surface of the MEA a separator plate having oxidant gas passages formed therein was laminated, and on another surface of the MEA a separator plate having fuel gas passages formed therein was laminated, to obtain a unit cell. Two of these unit cells were laminated together, then sandwiched by the separator plates having cooling passages formed therein, to obtain a laminate composed of two unit cells. A plurality of these laminates were laminated together to produce a cell stack containing 100 unit cells. Then, at both ends of the cell stack, a collecting plate made of stainless steel, an insulating plate made of an electrically insulating material and an end plate were fixed by fastening rods. The fastening pressure under this condition was 10 kgf/cm² per area of the separator plate.

The thus-produced polymer electrolyte fuel cell of this example was maintained at 80° C. A hydrogen gas humidified and heated so as to have a dew point of 75° C., and having a lowered carbon monoxide concentration of 50 ppm or less by modifying methane with water vapor, was fed to one electrode, and air humidified and heated so as to have a dew point of 50° C. was fed to another electrode.

This cell stack was subjected to a continuous power generation test under conditions of a fuel utilization of 85%, an oxygen utilization of 60% and a current density of 0.7 A/cm^{2.} Change of the output property over time was measured.

Tables 1 and 2 show various combinations of the catalyst layer, water-repellent layer and diffusion layer made according to the above-described procedures of Examples 8-41 and the results of the power generation tests on cell stacks using these combinations.

TABLE 1

| | | | | | | Properties after 5000 | |
|---|---|---|---|---|---|---|---|
| | | | | Initial properties | | hours | |
| Catalyst layer | | Water | Diffu-sion | | Voltage in | | Voltage in |
| Thick- | Catalyst | repellent layer | layer | Open | power | Open | power |
| ness | layer | Thickness | Thick-ness | voltage | generation at | voltage | generation at |
| (μm) | mg/cm² | (μm) | (μm) | (V) | 0.7 A/cm² | (V) | 0.7 A/cm² |
| 10 | 0.5 | 20 | 350 | 99.5 | 66.5 | 99.0 | 65.0 |
| 10 | 0.2 | 20 | 350 | 98.5 | 65.5 | 98.0 | 64.0 |
| 10 | 0.1 | 20 | 350 | 98.0 | 64.0 | 97.0 | 62.0 |
| 10 | 0.05 | 20 | 350 | 97.0 | 62.0 | 96.0 | 60.0 |
| 7 | 0.5 | 20 | 350 | 100.0 | 67.0 | 99.5 | 66.0 |
| 7 | 0.2 | 20 | 350 | 99.0 | 66.0 | 97.5 | 64.5 |
| 7 | 0.1 | 20 | 350 | 97.5 | 63.0 | 96.0 | 61.5 |
| 7 | 0.05 | 20 | 350 | 96.0 | 62.5 | 95.0 | 60.0 |
| 3 | 0.5 | 20 | 350 | 99.0 | 66.5 | 98.5 | 65.0 |
| 3 | 0.2 | 20 | 350 | 98.0 | 65.0 | 96.5 | 63.0 |
| 3 | 0.1 | 20 | 350 | 97.0 | 62.0 | 96.5 | 60.5 |
| 3 | 0.05 | 20 | 350 | 95.5 | 61.5 | 94.0 | 60.0 |
| 7 | 0.2 | 5 | 350 | 99.5 | 66.5 | 92.5 | 60.5 |
| 7 | 0.2 | 10 | 350 | 99.5 | 66.0 | 94.0 | 61.5 |
| 7 | 0.2 | 30 | 350 | 99.0 | 66.0 | 98.0 | 65.0 |
| 7 | 0.2 | 50 | 350 | 97.5 | 65.5 | 97.0 | 64.4 |
| 7 | 0.2 | 20 | 250 | 99.5 | 65.5 | 99.0 | 65.0 |
| 7 | 0.2 | 20 | 400 | 99.0 | 66.0 | 98.0 | 64.5 |

TABLE 2

| | | | | | | Properties after 5000 | |
|---|---|---|---|---|---|---|---|
| | | | | Initial properties | | hours | |
| Catalyst layer | | Water | Diffu-sion | | Voltage in | | Voltage in |
| Thick- | Catalyst | repellent layer | layer | Open | power | Open | power |
| ness | layer | Thickness | Thick-ness | voltage | generation at | voltage | generation at |
| (μm) | mg/cm² | (μm) | (μm) | (V) | 0.7 A/cm² | (V) | 0.7 A/cm² |
| 50 | 1.0 | 20 | 350 | 97.0 | 58.0 | 92.5 | 50.5 |
| 50 | 0.5 | 20 | 350 | 96.0 | 55.0 | 94.0 | 43.0 |
| 20 | 1.0 | 20 | 350 | 98.0 | 60.5 | 97.0 | 53.5 |
| 20 | 0.5 | 20 | 350 | 97.0 | 56.5 | 95.0 | 45.0 |
| 15 | 1.0 | 20 | 350 | 97.5 | 62.0 | 95.0 | 56.0 |
| 15 | 0.5 | 20 | 350 | 96.0 | 60.5 | 93.5 | 57.0 |
| 15 | 0.2 | 20 | 350 | 93.5 | 55.5 | 88.5 | 48.0 |
| 2 | 0.5 | 20 | 350 | 92.0 | 60.5 | 88.0 | 52.5 |
| 2 | 0.2 | 20 | 350 | 90.0 | 56.5 | 86.5 | 50.0 |
| 2 | 0.1 | 20 | 350 | 88.5 | 51.5 | 86.0 | 40.5 |
| 7 | 0.2 | 3 | 350 | 97.5 | 60.5 | 82.5 | 20.5 |
| 7 | 0.2 | 60 | 350 | 92.0 | 55.5 | 90.0 | 47.5 |
| 7 | 0.2 | 20 | 150 | 98.5 | 55.5 | 90.5 | 50.5 |
| 7 | 0.2 | 20 | 200 | 97.5 | 58.0 | 95.5 | 50.5 |
| 7 | 0.2 | 20 | 450 | 99.5 | 47.5 | 99.0 | 40.5 |
| 7 | 0.2 | 20 | 500 | 100.0 | 40.5 | 99.0 | 22.5 |

As apparent from the descriptions of the above-mentioned examples, when an electrode using a catalyst layer, water-repellent layer and diffusion layer having specific constitution ranges is used, a polymer electrolyte fuel cell having higher initial and long-term properties can be obtained. Since a catalyst layer can be produced without adding a pore-forming material in producing the catalyst layer, cost reduction and abbreviation of processes are possible. Further, by maintaining a lower porosity of the catalyst layer and decreasing the thickness of the catalyst layer, a cell of high performance can be obtained even at a lower humidification temperature.

That is, a particularly effective electrode and fuel cell can be produced where the thickness of the catalyst layer is in a range of about 3 μm to about 10 μm, the average thickness of parts of the water-repellent layer not intruding into the gas diffusion layer is in a range of about 5 μ m to about 50 μm, and the average thickness of the above-mentioned gas diffusion layer is in a range of about 250 μm to about 400 μm.

### EXAMPLES 42 TO 45

Next, the electroconductive carbon particles were investigated according to the following experimental examples.

The graphitized fine carbon powder (electroconductive carbon particle) has lower surface energy as compared with water, because its surface has a graphite structure and does not easily absorb moisture since the contact angle for water is large. Further, since the number of functional groups on the surface, such as —CO, —COOH, —CHO and —OH, decreases by thermal treatment at 2000° C. or more in the graphitization process, bonding forces with water are further suppressed. Therefore, the water repellency of the carbon powder is improved, leading to a lower tendency of wetting.

According to theory, there is a phenomenon in which fine carbon powder is gradually moistened by produced water and by water vapor added to the reaction gas for humidification of the polymer electrolyte, and in which dew is generated in fine pores of the catalyst layer and the gas diffusion layer. This clogs gas passages and lowers both gas feeding ability and dischargeability of produced water. By the graphitization process described below this phenomenon is suppressed, and high gas permeability and produced water dischargability can be obtained. As a result, higher cell performance is manifested for a long period of time, and the service life of the fuel cell is improved.

The electroconductive carbon particles of the present invention are obtained by graphitizing a carbon powder. As the carbon powder, conventionally known carbon black can be used, such as acetylene black, oil furnace black, channel black and thermal black, and powders of various classes can be used. Suitable commercially available powders include, for example, Vulcan™ XC-72 manufactured by Cabot K. K., Ketjen Black™ manufactured by Ketjen Black International K.K., N330 manufactured by Showa Denko K. K., and the like.

The particle size of the carbon powder may be about 10 to 70 nm, more preferably about 10 to 40 nm, for increase of the specific surface area for carrying the catalyst metal. Therefore, N330, N339, N326, N347, N351, N219, N220, N242, N285, N110, S301, S200, used.

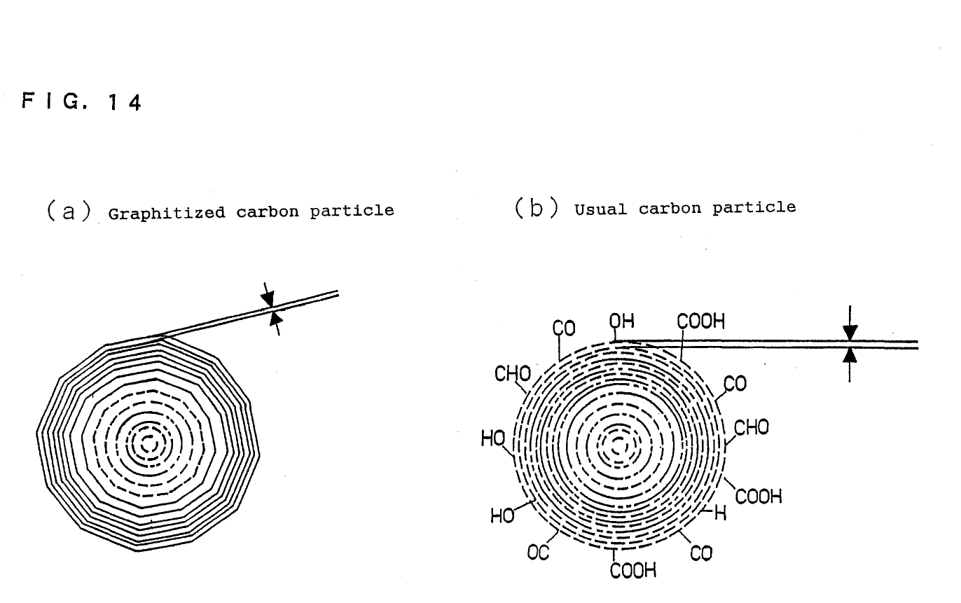

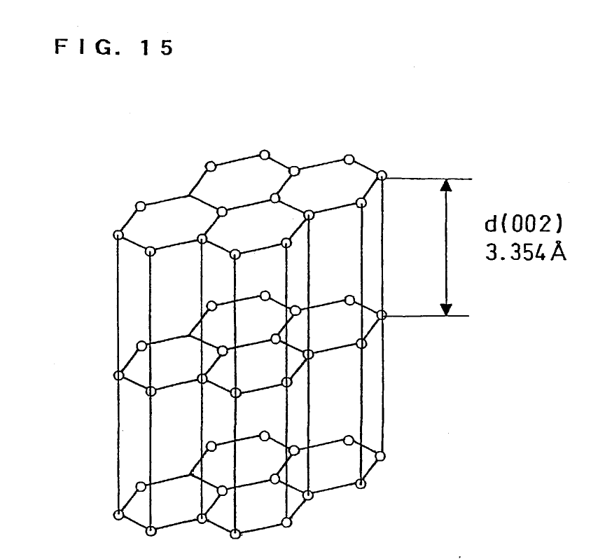

FIG. 14 shows a schematic sectional view of the structures of the primary particles of graphitized carbon powder (a) and a conventional carbon powder (b). FIG. 15 shows a conceptualized view of the crystal structure of natural graphite. Carbon Material Institute magazine, “Carbon Material Introduction” (tanso zairyo nyumon) p.180, and Jean-Baptiste Donnet, Andries Voer, “Carbon Black” (supervised and translated by Takahashi, Yamashita, Tsutsumi, Kodansha Scientific) pp.78 to 99 describe the fine crystal structure of carbon black, which is a carbon powder conventionally used in general. This is the structure shown in FIG. 15, according to X-ray diffraction. That is, as described, layers connecting hexa-carbon rings (carbon hexagonal network plane) are stacked to constitute a crystallite in the form of lamination structure of 3 to 4 layers in average at a plane spacing of 3.4 to 3.6 Å. Further, it is proved, according to various analyses by a high resolution electron microscope, that the inside portion of the particle is based not on fine crystals but on carbon hexagonal network planes. The network planes are stacked tightly in the form of concentric circles near the surface of particle, and are more disordered when approaching the center, and the network planes are present surrounding the peripheral parts of portions constituting the core of the particle. The network plane spacings of various carbon blacks, measured by electron beam diffraction, are about 3.5 to 3.9 Å.

FIG. 14(b) is a view schematically showing the cross section of the primary particle of carbon black, which is a general carbon powder.

On the other hand, the graphitized carbon powder can be obtained by thermally treating the carbon powder at a temperature from 2000 to 3000° C. under an inert gas atmosphere, such as argon or nitrogen.

By this thermal treatment, the fine particle surface of a primary particle of the carbon powder is carbonized, and a carbon hexagonal network plane structure of the surface is grown to form a cross-sectional structure as shown in FIG. 14 (a). Under this condition, the graphitized carbon powder of the present invention has extremely few surface functional groups as compared with the usual carbon powder having a lot of surface functional groups as shown in FIG. 14(b).

The above-mentioned Jean-Baptiste Donnet, Andries Voer, “Carbon Black” teaches that the boundary value of hard graphitization and easy graphitization of the lattice plane spacing d₀₀₂ of the (002) surface according to X-ray diffraction of a general carbon powder resides at 3.44 Å. While a usual carbon powder has a lattice plane spacing d002 of over 3.44 Å, the graphitized carbon powder has a lattice plane spacing d002 of 3.44 ÅA, revealing progressed graphitization. The lower limit of the lattice plane spacing d002 may be about 3.35 Å.

The electrode of the present invention is comprised of a gas diffusion layer and a catalyst layer, and the graphitized carbon powder is contained in at least one of these layers. Though various structures and production methods of an electrode are known, those skilled in the art can select and design among them within a range in which the effect of the present invention is not deteriorated.

For example, a gas diffusion layer is obtained in general by dispersing a carbon powder in a conductive porous substrate, such as carbon paper. The catalyst layer is obtained by applying a paste comprised of a polymer electrolyte and catalyst-carrying particles on the gas diffusion layer.

Further, when the electrode according to the present invention is used as a fuel electrode and an air electrode, a polymer electrolyte type fuel cell can be obtained comprising a polymer electrolyte membrane, a fuel electrode and an air electrode sandwiching the polymer electrolyte membrane, an electroconductive separator plate at the fuel electrode side having gas passages through which a fuel gas is fed to the fuel electrode, and an electroconductive separator plate at the air electrode side having gas passages through which an oxidant gas is fed to the air electrode. In this case, as the constituent elements, those conventionally known may be used, and these can be produced by ordinary methods by those skilled in the art.

Examples relating to the graphitized carbon powder were conducted as described below, in which three MEAs using electrodes according to the invention and a comparative MEA were made into fuel cells and tested.

MEA-a: Acetylene black in the form of a carbon powder (Denka Black™ manufactured by Denki Kagaku Kogyo K. K., particle size: 35 nm) was thermally treated for 60 minutes at 2500° C. under an atmosphere of argon gas, then, mixed with an aqueous dispersion of polytetrafluoroethylene (PTFE) (Lubron™ LDW-40 manufactured by Daikin Industries, Ltd.), to prepare a water-repellent ink containing PTFE in an amount of 20 wt % in terms of dry weight. This ink was applied on and impregnated into carbon paper (TGPH060H manufactured by Toray Industries, Inc.) as a substrate for the gas diffusion layer, and the ink-impregnated paper was heated at 300° C. by a hot air dryer to form a gas diffusion layer.

Further, 66 parts by weight of catalyst-carrying particles carrying 50 wt % of a Pt catalyst on carbon black powder (Ketjen Black™ EC manufactured by Ketjen Black International K.K., particle size: 30 nm) and 33 parts by weight of a perfluorocarbonsulfonic acid ionomer (5 wt % Nafion™ dispersion manufactured by Aldrich U.S.), as both a hydrogen ion conductive material and a binding agent, were mixed and molded to form a catalyst layer.

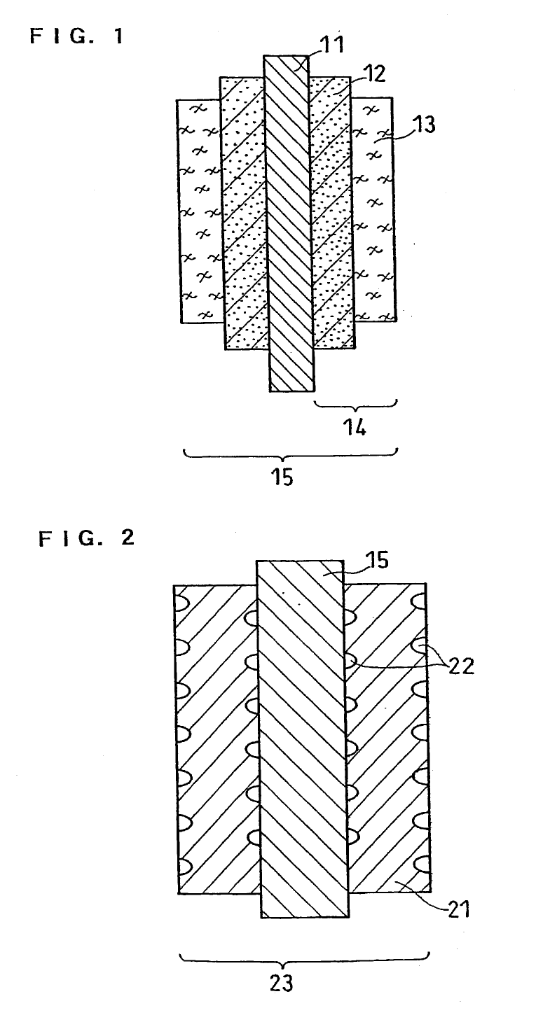

The gas diffusion layer and the catalyst layer obtained as described above were bonded to rolyte membrane (Nafion™ 112 membrane manufactured by E.I. Du Pont de Nemours and Company, U.S.) to produce MEA-a having the structure shown in FIG. 1.

MEA-b: Acetylene black (Denka Black™ manufactured by Denki Kagaku Kogyo K. K.) and PTFE aqueous dispersion (Lubron™ LDW-40 manufactured by Daikin Industries, Ltd.) were mixed to prepare a water-repellent ink containing 20 wt % of PTFE in terms of dry weight The ink was coated on carbon paper (TGPH060H, manufactured by Toray Industries, Inc.), as a gas diffusion substrate, and the coated substrate was thermally treated at 300° C. using a hot air drier to form a gas diffusion layer.

Further, carbon black powder (Ketjen Black™ EC manufactured by Ketjen Black International K.K.) was thermally treated at 2500° C. under an atmosphere of argon gas, and a Pt catalyst was allowed to be carried on this treated powder in an amount of 50 wt % to obtain catalyst-carrying particles. 66 parts by weight of the catalyst-carrying particles and 33 parts by weight of a perfluorocarbonsulfonic acid ionomer (5 wt % Nafion™ dispersion manufactured by Aldrich U.S.), as both a hydrogen ion conductive material and a binding agent, were mixed and molded to form a catalyst layer.

The gas diffusion layer and the catalyst layer obtained as described above were bonded to both surfaces of a polymer electrolyte membrane (Nafion™ 112 membrane manufactured by E. I. Du Pont de Nemours and Company, U.S.) to produce MEA-b having a structure shown in FIG. 1.

MEA-c: Acetylene black (Denka Black™ manufactured by Denki Kagaku Kogyo K. K.) was thermally treated for 60 minutes at 2500° C. under an atmosphere of argon gas, and then mixed with a polytetrafluoroethylene (PTFE) aqueous dispersion (Lubron™ LDW-40 manufactured by Daikin Industries, Ltd.) to prepare a water-repellent ink containing 20 wt % of PTFE in terms of dry weight. This ink was applied on carbon paper (TGPH060H, manufactured by Toray Industries, Inc.) constituting a substrate of a gas diffusion layer, and the inked substrate was thermally treated at 300° C. using a hot air drier to form a gas diffusion layer.

Further, carbon black powder (Ketjen Black™ EC manufactured by Ketjen Black International K.K.) was thermally treated at 2500° C. under an atmosphere of argon gas. A Pt catalyst was allowed to be carried on this treated powder in an amount of 50 wt % to obtain catalyst-carrying particles. 66 parts by weight of the catalyst-carrying particles and 33 parts by weight of a perfluorocarbonsulfonic acid ionomer (5 wt % Nafion™ dispersion manufactured by Aldrich U.S.), as both a hydrogen ion conductive material and a binding agent, were mixed and molded to form a catalyst layer.

The gas diffusion layer and the catalyst layer obtained as described above were bonded to both surfaces of a polymer electrolyte membrane (Nafion™ 112 membrane manufactured by E. I. Du Pont de Nemours and Company, U.S.) to produce MEA-c having a structure shown in FIG. 1.

MEA-x: Acetylene black (Denka Black™ manufactured by Denki Kagaku Kogyo K. K.) and PTFE aqueous dispersion (Lubron™ LDW-40 manufactured by Daikin Industries, Ltd.) were mixed to prepare a water-repellent ink containing 20 wt % of PTFE in terms of dry weight, and the ink was applied on carbon paper (TGPH060H, manufactured by Toray Industries, Inc.) constituting a substrate for the gas diffusion layer. The inked substrate was thermally treated at 300° C. using a hot air drier to form a gas diffusion layer.

Further, 66 parts by weight of catalyst-carrying particles carrying 50 wt % of a Pt catalyst on carbon black powder (Ketjen Black™ EC manufactured by Ketjen Black International K.K.) and 33 parts by weight of a perfluorocarbonsulfonic acid ionomer (5 wt % Nafion™ dispersion manufactured by Aldrich U.S.), as both a hydrogen ion conductive material and a binding agent, were mixed and molded to form a catalyst layer.

The gas diffusion layer and catalyst layer obtained as described above were bonded to both surfaces of a polymer electrolyte membrane (Nafion™ 112 membrane manufactured by E. I. Du Pont de Nemours and Company, U.S.) to produce MEA-x having a structure shown in FIG. 1.

Fuel Cells: A gasket plate made of rubber was connected to the outer peripheral parts of each of the polymer electrolyte membranes of the four MEAs produced as described above, and manifold apertures for passing cooling water, fuel gas and oxidant gas were formed therein.

Then, electroconductive separator plates were prepared comprised of a graphite plate impregnated with a phenol resin, having an outer dimension of 20 cm×32 cm×1.3 mm and having gas passages and cooling water passages of a depth of 0.5 mm. Two of these separator plates were used to obtain a unit cell. That is, the separator plate having oxidant gas passages formed therein was laminated on the front surface of the MEA, and the separator plate having fuel gas passages formed therein was laminated on the rear surface of MEA.

Two of these unit cells were laminated together, sandwiched by the separator plates having cooling water passage grooves formed therein, so that the grooves were positioned at the MEA side, to obtain a two cell laminate. This pattern was repeated to produce a 100 cell laminate (cell stack). Then, at both ends of the cell stack, a collecting plate made of stainless steel, an insulating plate made of an electrically insulating material and an end plate were disposed and fixed by fastening rods. The fastening pressure under this condition was 15 kgf/cm² per area of the separator plate.

The fuel cells produced by the above-mentioned methods using MEA-a, MEA-b, MEA-c and MEA-x were called cell A, cell B, cell C and cell X, respectively.

Evaluation tests: A pure hydrogen gas was fed to the fuel electrode, and air was fed to the air electrode, respectively, of the four cells obtained as described above, and a discharge test was conducted under conditions of a cell temperature of 75° C., a fuel gas utilization (Uf) of 70% and an air utilization (Uo) of 40%. The fuel gas was humidified by passing hot water at 70° C. and air was humidified by passing hot water at 50° C.

Further, into the fuel electrodes of the above-mentioned four cells, a 2 mol/L methanol aqueous solution was fed at a temperature of 60° C., as a typical example of a liquid fuel, and a cell discharge test as a direct type methanol fuel cell was conducted under conditions of a cell temperature of 75° C. and an air utilization (Uo) of 40%. Also in this case, air was passed through hot water at 50° C. for humidification.

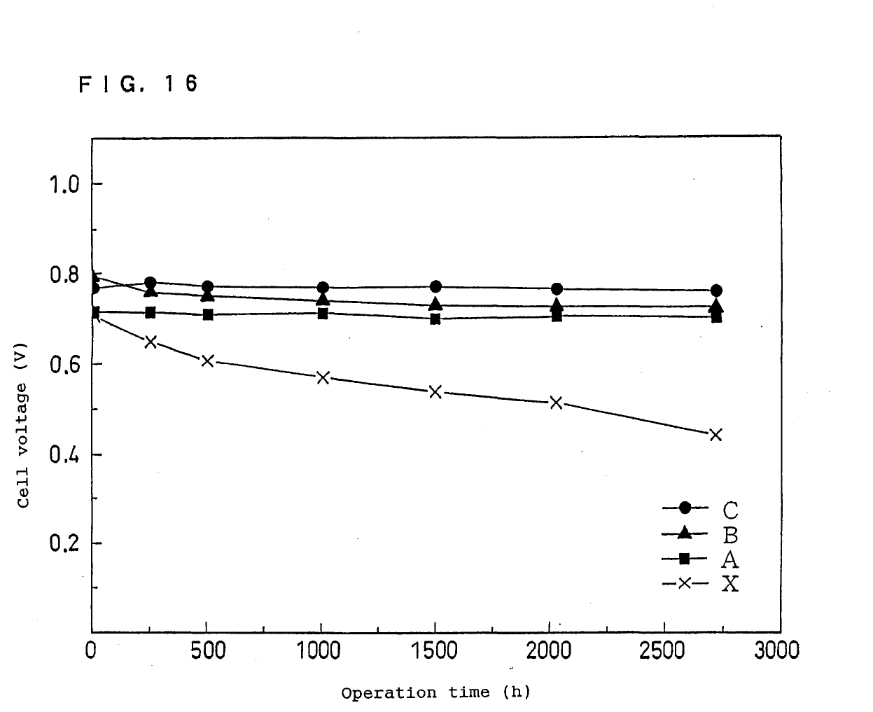

FIG. 16 shows the service lives of the above-mentioned cells A, B, C and X as hydrogen-air type fuel cells. FIG. 16 is a graph showing the relation of the operation time of a cell and voltage per cell (unit cell). The average unit cell voltages at a current density of 300 mA/cm² were 714 mV, 788 mV, 765 mV and 705 mV, respectively, as the initial voltages of the cells A, B, C and X. The voltages after 2700 hours were 699 mV, 720 mV, 755 mV and 441 mV, respectively. In contrast to a deteriorated voltage of 264 mV in the cell X, the cells A, B and C showed decreases of only 15 mV, 68 mV and 10 mV, respectively.

Thus, the effect of suppressing decrease in voltage was larger in the gas diffusion layer than in the catalyst layer. The cell in which the carbon powders had been graphitized, both in the catalyst layer and in the gas diffusion layer, showed the smallest decrease in voltage. This is a result of suppression of decrease in water repellency of the fine carbon powder in each layer and maintenance of gas diffusion ability and produced water dischargability for a long period of time. Further, the graphitization of the carbon particles also manifested an improvement of the initial voltage. This is a result of increase in the absolute amount of gas feeding ability.

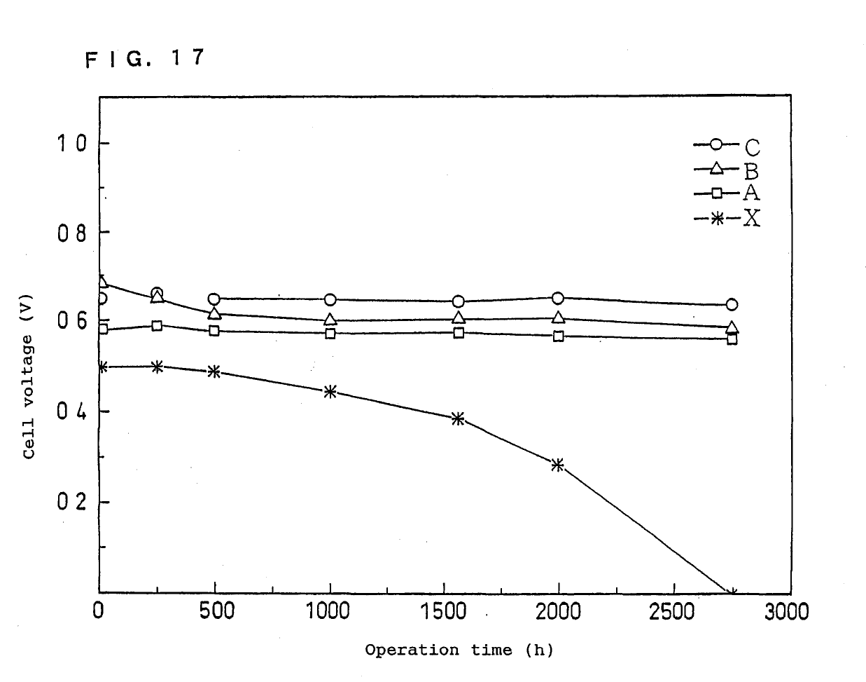

FIG. 17 shows the service lives of the cells A, B, C and X as liquid fuel cells. FIG. 17 is a graph showing the relation between the operation time of a cell and voltage per cell (unit cell). The average unit cell voltages at a current density of 200 mA/cm² were 580 mV, 681 mV, 650 mV and 498 mV, respectively, as the initial voltages of the cells A, B, C and X. The voltages after 2700 hours were 555 mV, 580 mV, 631 mV and 0 mV, respectively. In contrast to a deteriorated voltage of 498 mV of the cell X, the cells A, B and C showed decreases of only 25 mV, 101 mV and 19 mV, respectively.

Thus, it was confirmed that the graphitization effect on the carbon powder also manifested an improvement in a liquid fuel cell.

Table 3 shows the lattice plane spacing d₀₀₂ of the (002) plane according to X-ray diffraction measurement of a carbon powder, before and after the graphitization, and the moisture absorption amount of a carbon powder after being left for 24 hours at a temperature of 25° C. and a relative humidity of 70%.

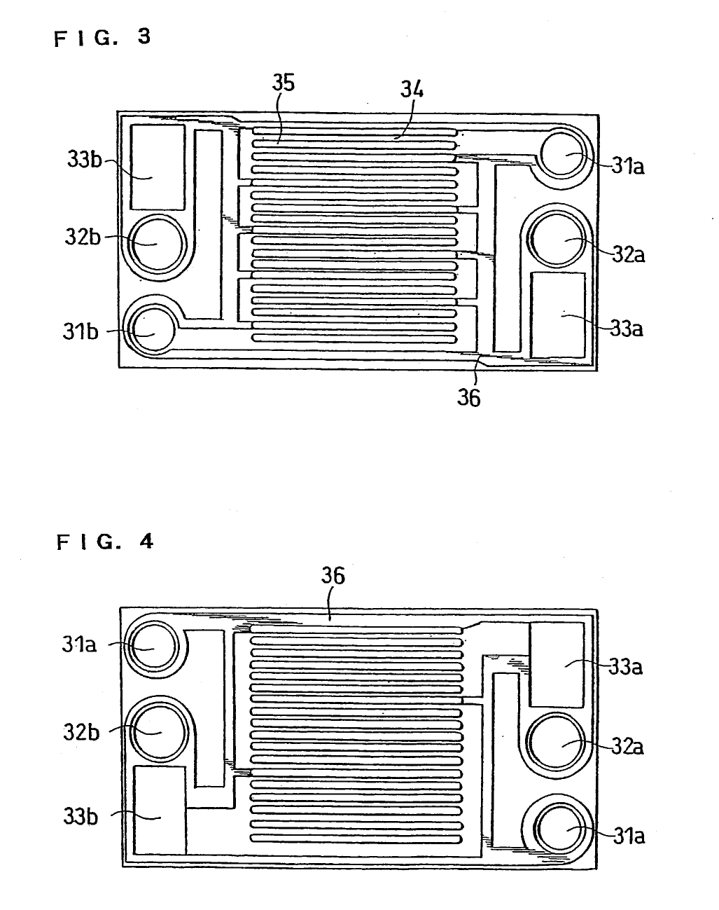

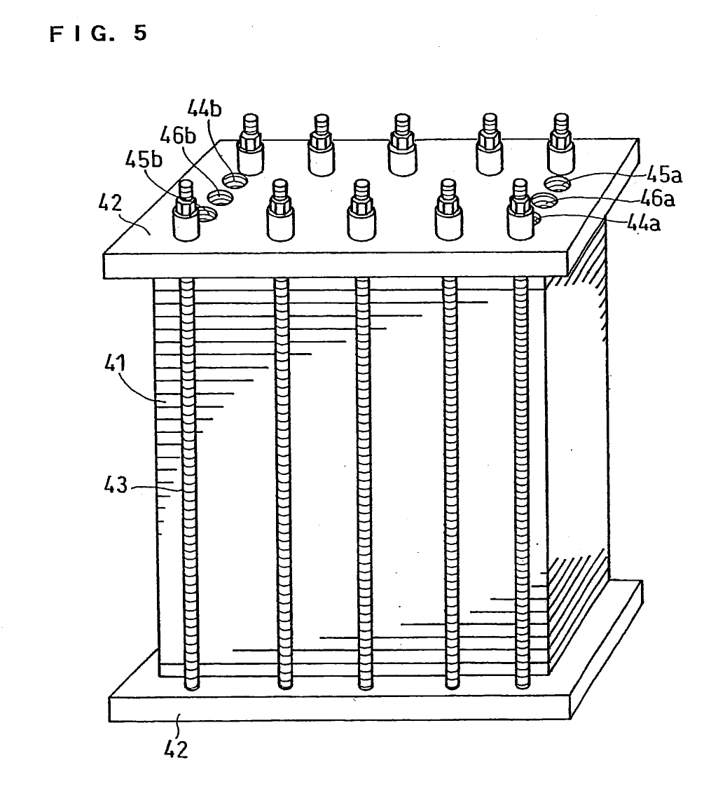

The above-mentioned acetylene black and Ketjen Black™ were used as a carbon powder. As shown in FIG. 3, the lattice plane spacing d₀₀₂ in a crystal structure decreased to 3.44 Å or lower by the graphitization treatment, revealing the progress of graphitization. The moisture absorption amount decreases from 0.054% to 0.032% and from 0.097% to 0.060% for acetylene black and Ketjen Black, respectively. It was found that the condition of the carbon powder was changed by the graphitization treatment, such that moisture was hardly absorbed. Therefore, it was found that the wetting property of the catalyst layer and the gas diffusion layer can be suppressed by using a carbon powder after graphitization treatment.

TABLE 3

| | Denka Black | | Ketjen Black | |
|---|---|---|---|---|
| | X ray | Moisture | X ray | Moisture |
| | network | absorption | network | absorption |
| | plane spacing | amount | plane spacing | amount |
| | d₀₀₂(Å) | (%) | d₀₀₂(Å) | (%) |
| Before graphi- | 3.48 | 0.054 | >3.50 | 0.097 |
| tization | | | | |
| After graphi- | 3.43 | 0.032 | 3.43 | 0.060 |
| tization | | | | |

In this example, hydrogen and methanol were used as a fuel. However, the same results were obtained even when fuel-modified hydrogen containing impurities, such as carbon dioxide gas, nitrogen and carbon monoxide is used as the hydrogen fuel. Further, the same results were obtained even when a fuel liquid, such as ethanol or dimethyl ether or a mixture thereof, was used instead of methanol. The liquid fuel may be pre-evaporated and fed as a vapor.

Furthermore, the structure of the gas diffusion layer of the present invention is not limited to the above-mentioned carbon powder and carbon paper, and an effect was obtained even when other carbon black and carbon cloth, such as Vulcan™ XC-72 and N330, were used.

As described above, according to the present invention, the degree of graphitization of a carbon powder is optimized in a fuel cell and an electrode. Further, a polymer electrolyte fuel cell and liquid fuel cell and an electrode used for them can be provided, which are capable of exhibiting higher performance while maintaining high gas diffusion properties and water discharging properties for a long period of time, by suppressing the water repellency of the catalyst layer and the gas diffusion layer and suppressing their deterioration over time.

### EXAMPLES 46 TO 48

Next, catalyst-carrying particles in a catalyst layer were further investigated according to the following experimental examples.

General Preparation Methods: For preventing catalyst particles from entering into the fine pores of the electroconductive carbon particles and for placing catalyst particles only on the outer surfaces of the electroconductive carbon particles, it may be advantageous that polar functional groups are allowed to be present only on the outer surfaces, that is on convex parts, of the electroconductive carbon particles. Then, particles of a noble metal are adhered by mutually reacting with the polar functional groups.

For allowing polar functional groups to be present only on the outer surfaces of electroconductive carbon particles, the electroconductive carbon particles are added into a solution prepared by dissolving or dispersing a compound having a polar functional group, or a solution of an organic acid or an inorganic acid. The viscosity of the solution used in this case is controlled within a range in which the solution does not enter fine pores of the electroconductive carbon particles. Specifically, solutions obtained by controlling the viscosity of an oxidant, such as nitric acid or hydrogen peroxide, or a silane coupling agent, such as 3-aminopropyltriethoxysilane, can be used. When an oxidant is used, a polar functional group, such as a carboxyl group or hydroxyl group, bonds to the surface of the electroconductive carbon particles, and when modified with a silane coupling agent, a polar functional group, such as an amino group, bonds to the surface.

When the surface of the electroconductive carbon particles is modified in liquid phase, the surface of the above-mentioned electroconductive carbon particles is coated with an inert liquid (i.e., inert with respect to the particles). Then, the electroconductive carbon particles are added to a solution prepared by dissolving or dispersing a compound having a polar functional group. By this procedure the outer surface of the electroconductive carbon particles can be modified more specifically. As the liquid inert to the electroconductive carbon particles, for example, water, alcohol, hydrocarbons, ketones, esters, silicone and the like can be used.

When noble metal particles are thus carried on electroconductive carbon particles having polar functional groups localized on their outer surfaces, electroconductive carbon particles having noble metal particles localized on their outer surfaces can be obtained. The reason is that, due to mutual interaction of noble metal particles and polar functional groups, the noble metal particles are easily carried on certain portions of the polar functional group.

The electroconductive carbon particles used here can carry noble metal particles at a higher concentration when the specific surface area of the particles is larger. The practical specific surface area is about 58 m²/g to about 1500 m²/g of particle weight. Noble metal particles show more excellent power generation efficiency at the same amount when their specific surface area is larger. The practical specific surface area of the catalyst is about 50 m²/g to about 250 m²/g per noble metal weight.

Unit Cell P: To 100 g of electroconductive carbon particles (Ketjen™ manufactured by Lion Corp., specific surface area: 800 m²/g) was added 1350 ml of water, and the mixture was stirred. The specific surface area was calculated according to a BET formula from nitrogen absorption using Sorptomatic™1800 manufactured by Carloelba. 150 ml of nitric acid was added dropwise, while heating and stirring in a vessel equipped with a reflux condenser, and reflux was continued for 2 hours. Then, centrifugal separation and washing with water were repeated. Electroconductive carbon particles having —OH group or —COOH group formed only on the surfaces were thereby obtained. Hereinafter, this process is called a modification process.

Next, 13.2 g of a 15.2 wt % aqueous solution of chloroplatinic acid was dissolved in 300 ml of water. To this was added 28.13 g of sodium hydrogen sulfite, and the mixture was stirred. Further, 1400 ml of water was added, and the mixture was stirred, and 60 ml of a 5% aqueous solution of sodium hydroxide was added to control pH to 5. Then, 240 ml of 30% hydrogen peroxide was added dropwise; further, 150 ml of an aqueous solution of sodium hydroxide was added to maintain pH at 5. To the resulting solution was added a mixture obtained by mixing and stirring 2.34 g of electroconductive carbon particles obtained in the above-mentioned modification process and 300 ml of water. The obtained mixture was heated while stirring by an ultrasonic homogenizer and boiled for 1 hour to allow platinum particles to be carried on the surfaces of the electroconductive carbon particles. Then, filtration and washing with water were repeated to allow the electroconductive carbon particles to carry the catalyst, thus obtaining catalyst-carrying particles.

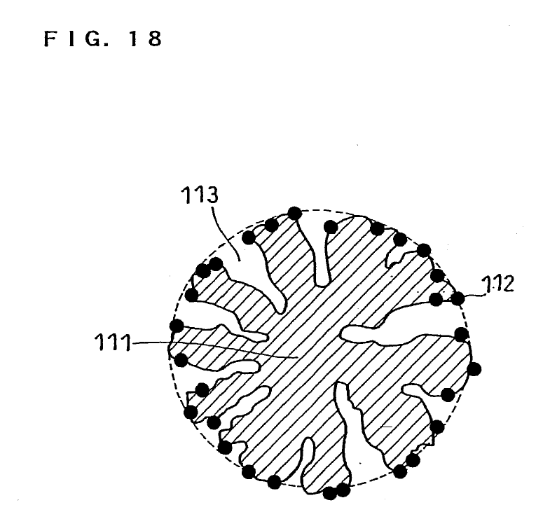

FIG. 18 shows a schematic sectional view of a catalyst-carrying particle, which carries catalyst particles only on the outer surfaces of the electroconductive carbon particle. As shown in FIG. 18, an electroconductive carbon particle 111 has fine pores 113, but catalyst particles 112 are carried only on the outer surface of the electroconductive carbon particle.

The catalyst-carrying particles were heated at 800° C. in the air to burn the electroconductive carbon particles, and the weight of the residue was measured to find that the carried amount of platinum was about 50 wt %. The specific surface area of the above-mentioned platinum was measured using an apparatus (manufactured by Okura Rika K. K.) for adsorbing carbon monoxide to find it was 150 m²/g per platinum weight.

A mixture obtained by mixing 2 g of the catalyst-carrying particles obtained in the above-mentioned process, 11 g of a solution containing a dispersed ion exchange resin (Flemion™ manufactured by Asahi Glass Co., Ltd., 9 wt % ethanol solution) and 5 g of water was applied on the surface of a polypropylene sheet by a bar coater, and the coated sheet was dried to obtain a catalyst layer. The application amount of the catalyst layer was controlled so that the platinum content was 0.2 mg per 1 cm².

An ion exchange membrane (Gore Select™ manufactured by Japan Goretex K. K., membrane thickness: 30 μm) was sandwiched by two of the above-mentioned polypropylene sheets with catalyst layer, so that the catalyst layers faced inside, and the obtained laminate was hot-pressed at 130° C. for 10 minutes. Then, the polypropylene sheets were removed, and an MEA was obtained by sandwiching with carbon papers (TGP-H-120 manufactured by Toray Industries, Inc., membrane thickness: 360 μm). The obtained MEA had a structure as shown in FIG. 1.

Using the above-mentioned MEA, a cell for measuring fuel cell properties (unit cell P) was manufactured and subjected to tests. The structure view of the unit cell is shown in FIG. 2.

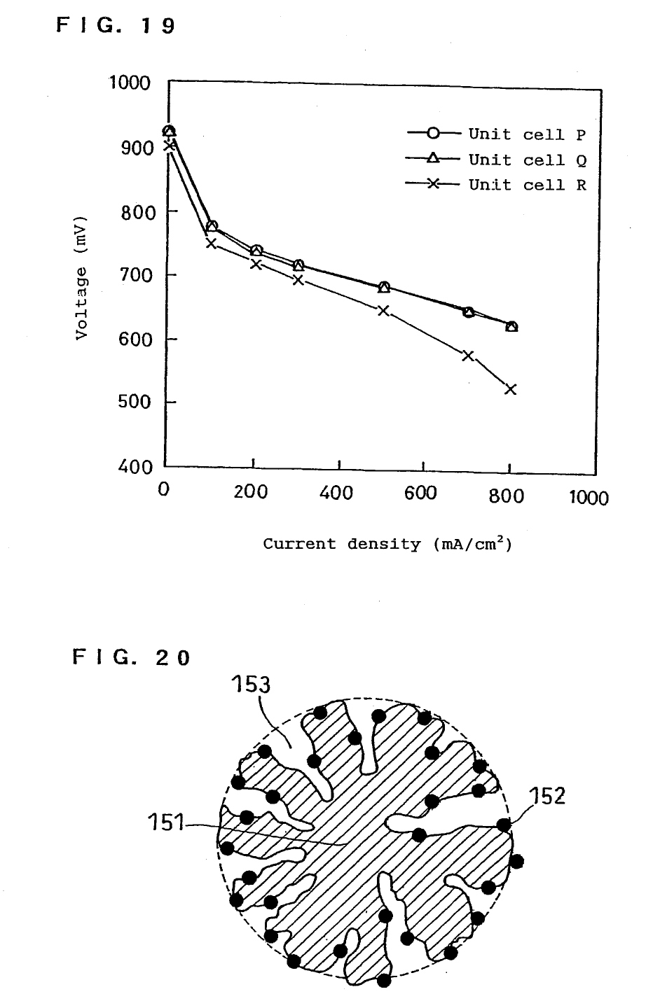

The temperature of the unit cell was set at 75° C., a hydrogen gas humidified to have a dew point of 80° C. was fed at a utilization of 80% to a fuel electrode, air humidified to have a dew point of 60° C. was fed at a utilization of 40% to an air electrode, and a discharge test was conducted. FIG. 19 shows a current-voltage (I-V) curve of the unit cell P. In Table 4 below current and voltage at 800 mA/cm² are shown.

Though Ketjen™ EC was used as the electroconductive carbon particles in the above, when Black-Pearls™ 2000 (manufactured by Cabot, specific surface area: 1500 m²/g) was used instead, the specific surface area of platinum became 250 m²/g per weight of platinum, obtaining the same result in the current-voltage (I-V) curve. When Acetylene Black (manufactured by Denki Kagaku Kogyo K. K., specific surface area: 58 m²/g) was used, the specific surface area of platinum was 50 m²/g per weight of platinum, obtaining approximately the same result though a tendency of slight decrease of the current-voltage (I-V) curve from that of Cell P in FIG. 19 was observed.

Unit Cell Q: Next, 100 g of electroconductive carbon particles (Ketjen™ EC manufactured by Lion Corp., specific surface area: 800 m²/g) was added into an aqueous solution of nitric acid, and the same surface modification as described above was conducted.

To the electroconductive carbon particles were added 1500 ml of ethanol, 150 ml of water and 60 ml of 25% ammonia water, and these were stirred. 40 ml of 3-aminopropyltriethoxysilane (manufactured by Shin-Etsu Chemical Co., Ltd.) was added dropwise, heated while stirring, refluxed, and reacted for 2 hours. Then, centrifugal separation and washing with water were repeated to obtain electroconductive carbon particles whose outer side was more strongly modified.

Next, 13.2 g of a 15.2 wt % aqueous solution of chloroplatinic acid was dissolved in 300 ml of water. To this was added 28.13 g of sodium hydrogen sulfite, and the mixture was stirred. Further, 1400 ml of water was added and the mixture was stirred, and 60 ml of a 5% aqueous solution of sodium hydroxide was added to control pH to 5. Then, 240 ml of 30% hydrogen peroxide was added dropwise; further, 150 ml of an aqueous solution of sodium hydroxide was added to maintain pH at 5. Then, 15.0 g of a 10 wt % aqueous solution of ruthenium chloride was added dropwise, and the mixture was stirred. To the resulting solution was added and stirred a mixture obtained by mixing 2.34 g of electroconductive carbon particles obtained via the above-mentioned modification process and 300 ml of water. The obtained mixture was heated while stirring by an ultrasonic homogenizer and boiled for 1 hour to allow platinum-ruthenium alloy particles to be carried on the surfaces of the electroconductive carbon particles. Then, filtration and washing with water were repeated to allow the electroconductive carbon particles to carry the catalyst, thus obtaining catalyst-carrying particles. The amount of carried platinum-ruthenium alloy was calculated to be about 50 wt % from the weight of the residue obtained when the catalyst-carrying particles were heated at 800° C. in the air to burn carbon. The specific surface area of noble metals determined by an apparatus (manufactured by Okura Rika K. K.) for adsorbing carbon monoxide was 160 m²/g per noble metal weight.

Using these catalyst-carrying particles, an MEA was produced of the same constitution as described above. Using this MEA, a cell for measuring fuel cell properties (unit cell Q) was manufactured and subjected to the same discharge test as described above. FIG. 19 shows a current-voltage curve of the unit cell Q. The cell voltage at 800 mA/cm² is shown in Table 4 below.

The properties when methanol was used as a fuel were also evaluated. A 2 mol aqueous solution of methanol was fed at a temperature of 60° C. as a fuel to a fuel electrode, the temperature of the unit cell was set at 75° C., and air humidified to have a dew point of 60° C. was fed at a utilization of 40% to the air electrode. A discharge test was conducted under these conditions. A cell voltage of 680 mV was obtained at a current density of 200 mA/cm².

Unit Cell R: Platinum was carried in the same manner as described above on electroconductive carbon particles (Ketjen™ EC, specific surface area: 800 m²/g), but not subjected to surface modification, to obtain catalyst-carrying particles. A schematic sectional view showing this catalyst-carrying particle is shown in FIG. 20. Catalyst particles 152 were carried also in the fine pores 153 of the electroconductive carbon particle 151. The amount of platinum carried was about 50 wt %. The specific surface area of platinum determined by an apparatus (manufactured by Okura Rika K. K.) for adsorbing carbon monoxide was 150 m²/g per platinum weight. Using these catalyst-carrying particles, an MEA having the same constitution as described above was produced.

Using this MEA, a cell for measuring fuel cell properties (unit cell R) was manufactured and subjected to the same discharge test as described above. FIG. 19 shows a current-voltage curve of the unit cell R. The cell voltage at 800 mA/cm² is shown in Table 4 below. When methanol was used as a fuel, a cell voltage of 400 mV was obtained at a current density of 200 mA/cm².

The above descriptions teach that, though the specific surface area itself of platinum hardly changes, the cell voltage (mV) at 800 mA/cm² is higher in the case of using electroconductive carbon particles subjected to surface modification. The reason for this is believed to be that platinum particles are localized on the outer surfaces of the electroconductive carbon particles, acting effectively as a catalyst.

TABLE 4
Voltage at 800 mA/cm²(mV)

| Unit cell P | Unit cell Q | Unit cell R |
|---|---|---|
| 632 | 632 | 530 |

As described above, by allowing catalyst particles to be carried only on the outer surfaces of the electroconductive carbon particles, a polymer electrolyte fuel cell having a lowercontent of noble metals can be provided, while maintaining high power generation efficiency. Further, the catalyst-carrying particles of the present invention can be applied also to other fuel cells, such as a direct methanol type fuel cell.

Industrial Applicability

According to the present invention, the relationship between the hydrogen ion conductive polymer electrolyte and catalyst particles and carbon particles in a catalyst layer of an electrode of a fuel cell are clarified, and a fuel cell having excellent power generation properties can be provided.

Also, according to the present invention, an optimum MEA capable of providing a fuel cell having an excellent power generation ability and a fuel cell power generation system showing excellent system efficiency can be provided. Particularly, the properties of the catalyst layer and the gas diffusion layer constituting the MEA, and a water-repellent layer capable of being formed between them, can be improved.

Further, according to the present invention, by optimizing the water repellency of a fine carbon powder in the catalyst layer and the gas diffusion layer, a fuel cell electrode exhibiting a higher ability, a polymer electrolyte type fuel cell, and a liquid fuel cell obtained by using this electrode, can be provided.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. An electrode for a fuel cell, wherein:
the electrode comprises a gas diffusion layer and a catalyst layer;
the catalyst layer comprises a hydrogen ion conductive polymer electrolyte and electroconductive carbon particles carrying catalyst particles; and
the hydrogen ion conductive polymer electrolyte and the electroconductive carbon particles in the catalyst layer satisfy the formula (1):
Y=a·logX−b+c
where log represents natural logarithm, X represents a specific surface area of the electroconductive carbon particles (m²/g), Y=(the weight of the hydrogen ion conductive polymer electrolyte)/(the weight of the electroconductive carbon particles), a=0.216, c=+0.300, b=0.421 at an air electrode and b=0.221 at a fuel electrode.

2. The electrode in accordance with claim 1, wherein the catalyst layer contains electroconductive carbon particles having a primary particle size in a range of about 10 nm to about 150 nm, a hydrogen ion conductive polymer electrolyte and platinum, and the catalyst layer has a thickness of about 3 μm to about 10 μm.

3. The electrode in accordance with claim 1, further comprising a water-repellent layer between the catalyst layer and the gas diffusion layer, wherein the water-repellent layer comprises electroconductive carbon particles having a primary particle size in a range of about 10 nm to about 150 nm and a water-repellent agent, such that portions of the water-repellent layer not intruding into the gas diffusion layer have an average thickness of about 5 μm to about 50 μm.

4. The electrode in accordance with claim 1, wherein the gas diffusion layer has an average thickness of about 250 μm to about 400 μm.

5. The electrode in accordance with claim 1, wherein the catalyst layer has a porosity of about 30% to about 70%.

6. The electrode in accordance with claim 2, wherein the water-repellent layer has a porosity of about 30% to about 60%.

7. The electrode in accordance with claim 1, wherein the hydrogen ion conductive polymer electrolyte in the catalyst layer has a main chain skeleton comprising a fluorocarbon and a side chain having an end group comprising a sulfonic acid or alkylsulfonic acid, and the electrolyte has an equivalent weight of about 80 g/Eq to about 1100 g/Eq. of sulfone group.

8. The electrode in accordance with claim 1, wherein the electroconductive carbon particles have a specific surface area of about 50 m²/g to about 1500 m²/g.

9. The electrode in accordance with claim 1, wherein the electroconductive carbon particles contain a graphitized carbon powder in an amount of at least about 33% by weight.

10. The electrode in accordance with claim 9, wherein a lattice plane spacing d₀₀₂ of the (002) plane in a crystal structure of the graphitized carbon powder is about 3.35 Å to about 3.44 Å.

11. The electrode in accordance with claim 9, wherein the graphitized carbon powder is one obtained by thermally treating a carbon powder at at least 2000° C.

12. The electrode in accordance with claim 1, wherein the electroconductive carbon particles have a specific surface area of about 58 m²/g to about 1500 m²/g, and the catalyst particles are carried only on an outer surface of the electroconductive carbon particles.

13. The electrode in accordance with claim 1, wherein the electroconductive carbon particles have present on an outer surface an end cation part composed of a polar functional group substituted by a catalyst cation.

14. The electrode in accordance with claim 1, wherein the catalyst particles have a specific surface area of about 50 m²/g to about 250 m²/g.

15. A membrane-electrode assembly (MEA) for a polymer electrolyte fuel cell, comprising a hydrogen ion conductive polymer electrolyte membrane, a pair of electrodes according to claim 1 disposed to sandwiching the hydrogen ion conductive polymer electrolyte membrane therebetween.

16. A polymer electrolyte fuel cell, comprising an MEA according to claim 15 and a pair of separator plates having gas passages feeding a fuel gas to and discharging a fuel gas from one of the electrodes and feeding an oxidant gas to and discharging an oxidant gas from another of the electrodes.

17. The fuel cell in accordance with claim 16, wherein the MEA has a sealing member around a peripheral part of each electrode, and a spacing between the electrode and the respective sealing member is about 10 μm to about 1 mm.
